(19) United States
(12) Patent Application Publication
(10) Pub. No.: US 2024/0370736 A1
(43) Pub. Date: Nov. 7, 2024

(54) MULTI MODAL PROMPTS FOR ZERO-SHOT MIXED TASKS

(71) Applicant: CHAOS INDUSTRIES, INC., Hermosa Beach, CA (US)

(72) Inventors: Andre Xian Ming CHANG, Hermosa Beach, CA (US); Eugenio CULURCIELLO, Hermosa Beach, CA (US); Abhishek CHAURASIA, Hermosa Beach, CA (US)

(21) Appl. No.: 18/636,051

(22) Filed: Apr. 15, 2024

Related U.S. Application Data
(60) Provisional application No. 63/499,438, filed on May 1, 2023.

(51) Int. Cl. G06N 3/096; G06N 3/0455

(52) U.S. Cl. CPC G06N 3/096; G06N 3/0455

(57) ABSTRACT

Multi modal models comprising an encoder and decoder are described. The encoder projects inputs into embeddings, which are used to generate a multi modal prompt, which is provided to the decoder. The encoder input comprises context information. The multi modal prompt comprises mixed types of data. This mixed data is converted into embeddings and combined to form the multi modal prompt. For example, text may be converted to embeddings using a text encoder and images may be converted to embeddings using an image encoder. The same encoder used for context can be used (encoder weight sharing). The mixed embeddings are then fed into the decoder's multi-attention head to guide output generation. A model can be trained to learn the generic associativity of multi modal prompts. Once trained using generic tasks, a model can be deployed to tackle multiple tasks zero-shot, without finetuning on new data types.

### BACKGROUND

### 1. Cross-Reference to Related Applications

This application claims the benefit of priority to U.S. Provisional Application No. 63/499,438, filed on May 1, 2023. The entire content of the foregoing patent application is incorporated herein by reference, including all text, tables and drawings in its entirety.

### 2. Field

The present disclosure relates generally to multi modal prompts for zero-shot mixed tasks.

### 3. Description of the Related Art

Large Language Models (LLM) are formed by a stack of transformer layers. They are trained for Natural Language Processing (NLP) tasks such as text generation, text summarization, text sentiment analysis, and text translation. Using a large corpus of data (e.g., from the internet) a LLM is able to learn various complex concepts. A LLM can accomplish various text related tasks given a prompt that shows examples of how to perform a task. Instructing a model to perform different tasks without training steps (without finetuning) is called zero-shot prediction. A LLM can generate zero-shot predictions when a prompt is well-formulated and the LLM has previously performed a large collection of different, but related, text tasks. The LLM may generate better or worse results depending how a prompt is formulated.

A combination of transformers and vision models facilitated the creation of vision transformer (ViT) models that solve vision related tasks using transformers. It is common to use an encoder ViT connected by a decoder transformer model. However, the prompts for such models are still text commands. It is also possible to mix embeddings (e.g., for inputs having different modalities), and for a correlation of embeddings across different modalities, e.g.: text, vision, audio, video. However, in order to add a new feature into existing models, one must finetune the model with new data. For example: in textual inversion, one must finetune the model to add a person A or B into the model representation so the model can generate personalized images. The model cannot perform this task zero-shot based on a prompt.

### SUMMARY

The following is a non-exhaustive listing of some aspects of the present techniques. These and other aspects are described in the following disclosure.

Multi modal models comprising an encoder and decoder are described. The encoder projects inputs into embeddings, which are used to generate a multi modal prompt, which is provided to the decoder. The encoder input comprises context information. The multi modal prompt comprises mixed types of data. This mixed data is converted into embeddings and combined to form the multi modal prompt. For example, text may be converted to embeddings using a text encoder and images may be converted to embeddings using an image encoder. The same encoder used for context can be used (encoder weight-sharing). The mixed embeddings are then fed into the decoder's multi-attention head to guide output generation. A model can be trained to learn the generic associativity of multi modal prompts. Once trained using generic tasks, a model can be deployed to tackle multiple tasks zero-shot, without finetuning on new data types. In some embodiments, the multi modal models comprise a LLM that can zero-shot different modalities by using multi modal prompts-prompts that comprise a mixture of embeddings from different modalities.

Some aspects include a method for outputting a zero-shot learning response to a multi modal prompt using a trained parameterized model. The trained parameterized model comprises encoder decoder architecture. The method comprises receiving multi modal inputs from a user. The multi modal inputs comprise at least two different input modality types. The method comprises encoding, with an encoder of the encoder decoder architecture, features of the multi modal inputs to form the multi modal prompt. The multi modal prompt comprises embedded features of mixed modalities from the at least two different input modality types. The method comprises providing the prompt to a decoder of the encoder decoder architecture to cause the decoder to output the response based on the multi modal prompt. The decoder is configured to output the response without prior training on at least one of the multi modal inputs received from the user.

In some embodiments, the multi modal inputs having the at least two different input modality types comprise two or more of text, image, video, audio, signal, byte sequence, code, and electromagnetic inputs. In some embodiments, the electromagnetic inputs comprise radiofrequency (RF) waves, microwaves, light waves, and/or infrared radiation. In some embodiments, the at least two different input modality types comprises at least three different input modality types.

In some embodiments, the method comprises receiving context information from the user, encoding the context information, and causing the decoder to output the response based on the multi modal prompt and encoded context information.

In some embodiments, the encoder need not be retrained to encode different multimodal inputs from the user, and instead is configured to be reused. The encoder is configured to encode both the features of the multi modal inputs to form the multi modal prompt and the context information to feed the decoder directly, without any added layers for combining features of different modes.

In some embodiments, the trained parameterized model comprises a large language model. In some embodiments, the trained parameterized model comprises a transformer. In some embodiments, the trained parameterized model comprises a parietal space. In some embodiments, the trained parameterized model comprises one or more neural networks. In some embodiments, the encoder comprises a first neural network. In some embodiments, the decoder comprises a second neural network. In some embodiments, the trained parameterized model and/or the encoder decoder architecture comprises one or more adapters.

In some embodiments, the multi modal prompt comprises a single prompt, no matter how many different input modality types are included in the multi modal inputs received from the user.

In some embodiments, only key features of each of the multi modal inputs are encoded to form the multi modal prompt such that the multi modal prompt is relatively low dimensional compared to a dimensionality of any of the multi modal inputs. The key features are more predictive than other features of correct outputs during training of the parameterized model.

In some embodiments, training of the parameterized model is supervised or unsupervised. In some embodiments, the training configures the parameterized model to learn a generic associativity of multi modal prompts, and once trained, to be deployed to output the zero-shot learning response to the multi modal prompt, without finetuning on new data types.

In some embodiments, the parameterized model is configured to solve a task involving new multi modal inputs by finding a closest match to the multi modal prompt in an embedding space, and then assigning the multi modal prompt to a most relevant class based on a similarity of the multi modal prompt to the most relevant class;

In some embodiments, the decoder comprises a transformer decoder; and, given a new input modality feature, the transformer decoder is finetuned for a task that uses the new input modality of the feature, such that the parameterized model adapts how to best project input features into an internal embedding space of the parameterized model.

In some embodiments, the decoder comprises a multi-attention head configured to receive the multi modal prompt and guide generation of the output response.

In some embodiments, the multi modal inputs having the at least two different input modality types comprise a first input comprising text, and a second input comprising an image, a video, audio input, a signal, a byte sequence, code, or an electromagnetic input, for example. In some embodiments, the multi modal inputs having the at least two different input modality types comprise a first input comprising an image, a video, audio input, a signal, a byte sequence, code, or an electromagnetic input, and a second input comprising a different one of the image, video, audio input, signal, byte sequence, code, or electromagnetic input, for example.

In some embodiments, encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

In some embodiments, at least a portion of the response output by the trained parameterized model is provided as feedback to the trained parameterized model. The portion of the response output by the trained parameterized model provided as feedback may be used as input for subsequent responses by the trained parameterized model. In some embodiments, the feedback is configured to iteratively refine the input to the trained parameterized model, while the trained parameterized model itself remains the same. In some embodiments, the feedback is used as input that is separate from, and in addition to, the multi modal inputs from the user. In some embodiments, the feedback comprises code, the output of executed code, and/or other feedback for example.

In some embodiments, the trained parameterized model is configured to store embedded features of mixed modalities from prior prompts in a feature database to create a library of features, to be used in combination with later inputs, prompts, context information, and/or other information to output responses. In some embodiments, using stored features to output responses to later prompts comprises performing a hierarchical feature search of the feature database and/or an external database to efficiently identify features related to a user query that can be provided as input to the trained parameterized model.

In some embodiments, the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.

Some aspects include a tangible, non-transitory, machine-readable medium storing instructions that when executed by a data processing apparatus cause the data processing apparatus to perform operations including the above-mentioned method.

Some aspects include a system, including: one or more processors; and memory storing instructions that when executed by the processors cause the processors to effectuate operations of the above-mentioned method.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical-architecture block diagram that illustrates a system configured to receive multi modal prompts for zero-shot mixed tasks.

FIG. 2 illustrates a generalized example of encoder decoder architecture.

FIG. 3 illustrates a base example of a multi modal model that includes an encoder and a decoder.

FIG. 4 illustrates another example embodiment of a multi modal model.

FIG. 5 illustrates a first example task that may be performed by the system of FIG. 1.

FIG. 6 illustrates a second example task that may be performed by the system of FIG. 1.

FIG. 7 illustrates another example embodiment of a multi modal model.

FIG. 8 illustrates additional details related to one or more of the example multi modal models illustrated in prior figures.

FIG. 9 illustrates additional details related to one or more of the example multi modal models illustrated in prior figures.

FIG. 10 illustrates additional details related to one or more of the example multi modal models illustrated in prior figures.

FIG. 11 illustrates additional details related to one or more of the example multi modal models illustrated in prior figures.

FIG. 12 illustrates additional details related to one or more of the example multi modal models illustrated in prior figures.

FIG. 13 illustrates an example use case for one or more of the example multi modal models illustrated in prior figures.

FIG. 14 illustrates using one or more of the example multi modal models illustrated in prior figures to make predictions and/or generate other outputs.

FIG. 15 illustrates using one or more of the example multi modal models illustrated in prior figures, in combination with information from a features database, to make predictions and/or generate other outputs, in contrast to what is shown in FIG. 14.

FIG. 16 illustrates another example use case for one or more of the example multi modal models illustrated in prior figures.

FIG. 17 is a diagram that illustrates an exemplary computing system in accordance with embodiments of the present system.

FIG. 18 is a flowchart of a method for outputting a zero-shot learning response to a multi modal prompt using a trained parameterized model.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of computer vision and natural language process (NLP), and other fields. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

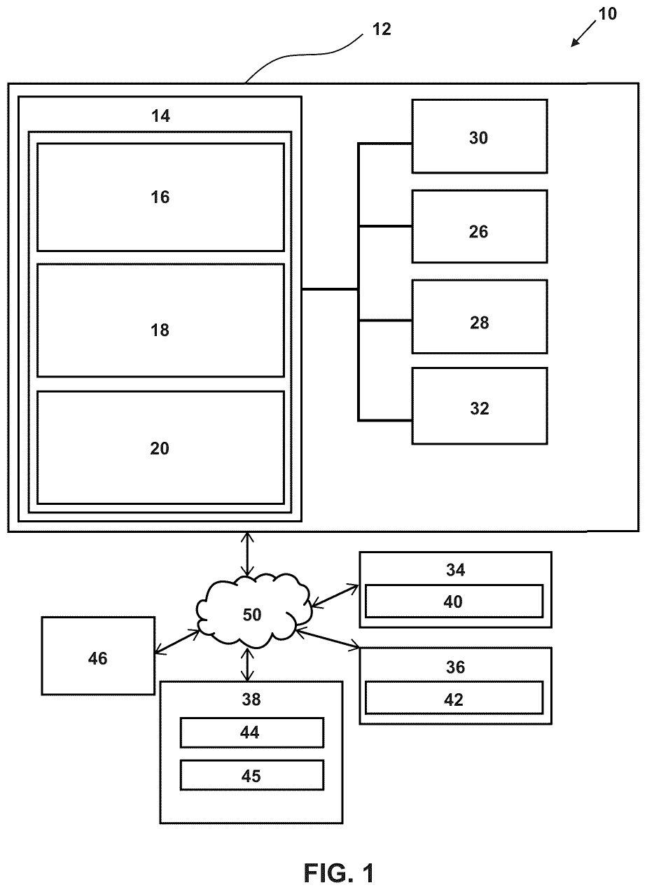

FIG. 1 illustrates a system 10 comprising an output engine 12 and other components configured to output a zero-shot learning response to a multi modal prompt using a trained parameterized (multi modal) model. The trained parameterized (multi modal) model comprises encoder decoder architecture.

System 10 can be applied to computer vision, natural language processing (NLP), control systems (e.g., for artificially intelligent cars, robots, etc.), document processing, security, data analytics, recommender systems, and/or other applications. The multi modal prompt framework described below facilitates completion of vision, NLP, and/or other tasks in a zero-shot scenario (e.g., without finetuning the described model(s)). By using image examples combined with textual prompts (and/or other prompts of other mode types), system 10 is configured such that a user can command system 10 (e.g., including the model(s) described below) to tackle various different tasks in zero-shot. For example, a user can ask system 10 to complete a task, and give an example of how to perform task related object detection, classification, document parsing, etc., so that system 10 may complete the task.

Some prior multi modal models include an encoder and a decoder. As in system 10, the encoder projects inputs into embeddings, which are provided to the decoder. The encoder input comprises context and/or other information. The decoder is configured to generate an output. Prompting is performed by providing the multi modal model with text commands. The prompt is configured to guide the decoder to generate the output according to the prompt. For example: in a text summarization example, the context may include a copy of a text that a user needs summarized, translated, etc., and the prompt may comprise a text command such as: “give me the summary”, “translate to Spanish”, etc. The same model may perform either of these two tasks based on the same context, but different prompts.

However, such models are limited for several other applications. For example, if context provided as input comprises a video of a public event, and the prompt is: “what is person A doing, and where is person B”, but the model has never been trained on the appearance of person A or person B, the model will not be able to complete the requested task based on the prompt. With multi modal prompting, as provided by system 10 and described below, a user can provide the following prompt: “what is person A is doing and where is person B, person A and person B look like <and insert an example image or images>”. By formulating a multi modal prompt (e.g., based on text and an image in this example) in an embedding space, system 10 is configured such that a user can mix any data types so that the model(s) described herein can accomplish more sophisticated tasks without training.

Advantageously, in system 10, an encoder projects inputs into embeddings, which are used to generate a multi modal prompt, which is provided to a decoder. The encoder input comprises context information. The multi modal prompt comprises mixed types of data. This mixed data is converted into embeddings and combined to form the multi modal prompt. For example, text may be converted to embeddings using a text encoder and images may be converted to embeddings using an image encoder. The same encoder used for context can be used (encoder weight-sharing). The mixed embeddings are then fed into the decoder's multi-attention head to guide output generation. A model can be trained to learn the generic associativity of multi modal prompts. Once trained using generic tasks, a model can be deployed to tackle multi-tasks zero-shot, even for new data types. In some embodiments, the multi modal models comprise a LLM that can zero-shot different modalities by using multi modal prompts-prompts that comprise a mixture of embeddings from different modalities.

The multi modal prompts described herein facilitate the use of any kind of data for commanding LLMs, the unlocking of potential new applications by skipping traditional steps needed for new types of data, with zero-shot mechanics that avoid large training costs and deployment time (of LLMs and/or other models). The multi modal prompts described herein also facilitate decoupling training datasets from a particular application. A model (e.g., a LLM) may be trained to have generic associativity capabilities instead of mimicking a particular dataset. During model deployment, a user can provide examples with any kind data to tell what the model (e.g. the LLM) what to do. This makes a given model a more generic task solver, and/or has other advantages.

These and other benefits are described in greater detail below, after introducing the components of system 10 and describing their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

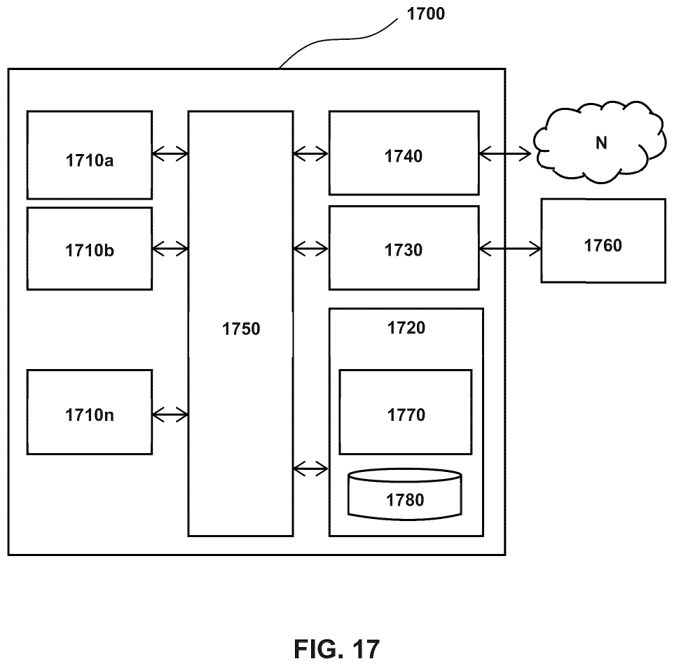

In some embodiments, output engine 12 is executed by one or more of the computers described below with reference to FIG. 17 and may include one or more of a controller 14, an application program interface (API) server 26, a web server 28, a data store 30, and a cache server 32. These components, in some embodiments, communicate with one another in order to provide the functionality of output engine 12 described herein.

Cache server 32 may expedite access to relevant data by storing likely relevant data in relatively high-speed memory, for example, in random-access memory or a solid-state drive. Web server 28 may serve webpages having graphical user interfaces that display one or more views that facilitate receiving entry or selection of input from a user (e.g., including a command that system 10 perform a certain task, context information, etc.), and/or other views. API server 26 may serve data to various applications that process data related to user requested tasks, or other data. The operation of these components 26, 28, and 30 may be coordinated by controller 14, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users and/or other entities may occur via a website or a native application viewed on a desktop computer, tablet, or a laptop of the user. In some embodiments, such interaction occurs via a mobile website viewed on a smart phone, tablet, or other mobile user device, or via a special-purpose native application executing on a smart phone, tablet, or other mobile user device. Data may be extracted by controller 14 and/or other components of system 10 from data store 30 and/or other sources inside or outside system 10 in a secure and encrypted fashion. Data extraction by controller 14 may be configured to be sufficient for system 10 to function as described herein, without compromising privacy and/or other requirements associated with a data source. Outputting a zero-shot learning response to a multi modal prompt using a trained parameterized model across a variety of devices is expected to make it easier for users to request and/or receive such information when and where convenient for the user, and/or have other advantageous effects.

To illustrate an example of the environment in which output engine 12 operates, the illustrated embodiment of FIG. 1 includes a number of components with which output engine 12 communicates: mobile user devices 34 and 36; a desk-top user device 38; and external resources 46. Each of these devices communicates with output engine 12 via a network 50, such as the Internet or the Internet in combination with various other networks, like local area networks, cellular networks, Wi-Fi networks, or personal area networks.

Mobile user devices 34 and 36 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user devices 34 and 36 may store instructions that when executed by the associated processor provide an operating system and various applications, including a web browser 42 and/or a native mobile application 40. The desktop user device 38 may also include a web browser 44 a native application 45, and/or other electronic resources. In addition, desktop user device 38 may include a monitor; a keyboard; a mouse; memory; a processor; and a tangible, non-transitory, machine-readable memory storing instructions that when executed by the processor provide an operating system and the web browser 44 and/or the native application 45.

Native applications and web browsers 40, 42, 44, and 45, in some embodiments, are operative to provide a graphical user interface associated with a user, for example, that communicates with output engine 12 and facilitates user interaction with data from output engine 12. In some embodiments, output engine 12 may be stored on and/or otherwise be executed user computing resources (e.g., a user computer, server, etc., such as mobile user devices 34 and 36, and desktop user device 38 associated with a user), servers external to the user, and/or in other locations. In some embodiments, output engine 12 may be run as an application (e.g., an app such as native application 40) on a server, a user computer, and/or other devices.

Web browsers 42 and 44 may be configured to receive a website from output engine 12 having data related to instructions (for example, instructions expressed in JavaScript™) that when executed by the browser (which is executed by the processor) cause mobile user device 36 and/or desktop user device 38 to communicate with output engine 12 and facilitate user interaction with data from output engine 12. Native application 40 and 45, and web browsers 42 and 44, upon rendering a webpage and/or a graphical user interface from output engine 12, may generally be referred to as client applications of output engine 12, which in some embodiments may be referred to as a server. Embodiments, however, are not limited to client/server architectures, and output engine 12, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, and/or multiple countries across the world.

External resources 46, in some embodiments, include sources of information such as databases, websites, etc.; external entities participating with the system 10, one or more servers outside of the system 10, a network (e.g., the internet), electronic storage, equipment related to Wi-Fi™ technology, equipment related to Bluetooth® technology, data entry devices, or other resources. In some implementations, some or all of the functionality attributed herein to external resources 46 may be provided by resources included in system 10. External resources 46 may be configured to communicate with output engine 12, mobile user devices 34 and 36, desktop user device 38, and/or other components of the system 10 via wired and/or wireless connections, via a network (e.g., a local area network and/or the internet), via cellular technology, via Wi-Fi technology, and/or via other resources.

Thus, output engine 12, in some embodiments, operates in the illustrated environment by communicating with a number of different devices and transmitting instructions to various devices to communicate with one another. The number of illustrated external resources 46, desktop user devices 38, and mobile user devices 36 and 34 is selected for explanatory purposes only, and embodiments are not limited to the specific number of any such devices illustrated by FIG. 1, which is not to imply that other descriptions are limiting.

Output engine 12 may include a number of components introduced above that facilitate outputting a zero-shot learning response to a multi modal prompt using a trained parameterized (multi modal) model. For example, the illustrated API server 26 may be configured to communicate user input text commands, input images, and/or other information via a protocol, such as a representational-state-transfer (REST)-based API protocol over hypertext transfer protocol (HTTP) or other protocols. Examples of operations that may be facilitated by the API server 26 include requests to complete a zero-shot task, and/or other information. API requests may identify which output data is to be displayed linked, modified, added, or retrieved by specifying criteria for identifying tasks, such as queries for retrieving or processing information about a particular subject (e.g., a subject's appearance along with certain contextual information as described in the example above). In some embodiments, the API server 26 communicates with the native application 40 of the mobile user device 34, the native application 45 of the desktop user device 38, and/or other components of system 10.

The illustrated web server 28 may be configured to display, link, modify, add, or retrieve portions or all of a multi modal user input, a zero-shot learning response to a multi modal prompt, and/or other information encoded in a webpage (e.g. a collection of resources to be rendered by the browser and associated plug-ins, including execution of scripts, such as JavaScript™, invoked by the webpage). In some embodiments, the graphical user interface presented by the webpage may include inputs by which the user may enter or select data, such as clickable or touchable display regions or display regions for text input. For example, context information comprising one or more images may be uploaded, in combination with one or more entered text commands. Such inputs may prompt the browser to request additional data from the web server 28 or transmit data to the web server 28, and the web server 28 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 28 may communicate with web browsers, such as the web browser 42 or 44 executed by user devices 36 or 38. In some embodiments, the webpage is modified by the web server 28 based on the type of user device, e.g., with a mobile webpage having fewer and smaller images and a narrower width being presented to the mobile user device 36, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and the web server 28 may select the appropriate interface based on this embedded identifier, thereby providing an interface appropriately configured for the specific user device in use.

The illustrated data store 30, in some embodiments, stores and/or is configured to access data required to receive a multi modal user input and/or generate a zero-shot learning response, and/or other information. Data store 30 may include various types of data stores, including relational or non-relational databases; image, document, etc., collections; and/or programming instructions related to storage and/or execution of one or more of the models described herein, for example. Such components may be formed in a single database, or may be stored in separate data structures. In some embodiments, data store 30 comprises electronic storage media that electronically stores information. The electronic storage media of data store 30 may include one or both of system storage that is provided integrally (i.e., substantially non-removable) with system 10 and/or other storage that is connectable (wirelessly or via a wired connection) to system 10 via, for example, a port (e.g., a USB port, a firewire port, etc.), a drive (e.g., a disk drive, etc.), a network (e.g., the Internet, etc.). Data store 30 may be (in whole or in part) a separate component within system 10, or data store 30 may be provided (in whole or in part) integrally with one or more other components of system 10 (e.g., controller 14, external resources 46, etc.). In some embodiments, data store 30 may be located in a data center, in a server that is part of external resources 46, in a computing device 34, 36, or 38, and/or in other locations. Data store 30 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 30 may store software algorithms, information determined by controller 14, information received via the graphical user interface displayed on computing devices 34, 36, and/or 38, information received from external resources 46, or other information accessed by system 10 to function as described herein.

Controller 14 is configured to coordinate the operation of the other components of output engine 12 to provide the functionality described herein. Controller 14 may be formed by one or more processors, for example. Controller 14 may comprise one or more of an input component 16, an encoding component 18, a decoding component 20, and/or other components. Controller 14 may be configured to direct the operation of components 16, 18, and/or 20 by software; hardware; firmware; some combination of software, hardware, or firmware; machine-readable instructions; or other mechanisms for configuring processing capabilities.

It should be appreciated that although components 16, 18, and 20 are illustrated in FIG. 1 as being co-located, one or more of components 16, 18, and/or 20 may be located remotely from the other components. The description of the functionality provided by the different components 16, 18, and/or 20 described below is for illustrative purposes, and is not intended to be limiting, as any of the components 16, 18, and/or 20 may provide more or less functionality than is described, which is not to imply that other descriptions are limiting. For example, one or more of components 16, 18, and/or 20 may be eliminated, and some or all of its functionality may be provided by others of the components 16, 18, and/or 20, again which is not to imply that other descriptions are limiting. As another example, controller 14 may be configured to control one or more additional components that may perform some or all of the functionality attributed below to one of the components 16, 18, and/or 20. In some embodiments, output engine 12 (e.g., controller 14 in addition to cache server 32, web server 28, and/or API server 26) is executed in a single computing device, or in a plurality of computing devices in a datacenter, e.g., in a service oriented or micro-services architecture.

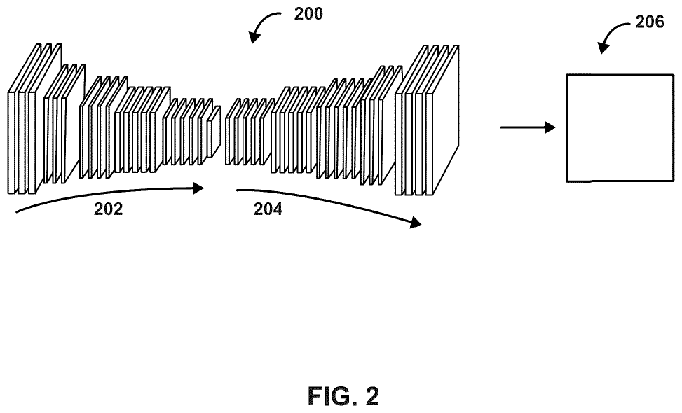

As described above, system 10 is configured to output a zero-shot learning response to a multi modal prompt using a trained parameterized (multi modal) model. The trained parameterized model comprises encoder decoder architecture. FIG. 2 illustrates a generalized example of encoder decoder architecture 200. Encoder decoder architecture 200 has an encoding portion (an encoder 202) and a decoding portion (a decoder 204). In the example shown in FIG. 2, encoder decoder architecture 200 may output a zero-shot learning response 206 and/or other outputs, for example.

Encoder 202 is configured to encode an input into a low dimensional encoding or embedding space. For example, encoder 202 may be configured to encode features of multi modal inputs to form a low dimensional encoding or embedding such as a multi modal prompt in the low dimensional embedding space. In some embodiments, the low dimensional embedding represents one or more features of an input. The one or more features of the input may be considered key or critical features of the input. Features may be considered key or critical features of an input because they are relatively more predictive than other features of a desired output and/or have other characteristics, for example. The one or more features (dimensions) represented in the low dimensional embedding may be predetermined (e.g., by a programmer at the creation of the present modular autoencoder model), determined and/or otherwise learned by prior layers of a neural network, adjusted by a user via a user interface associated with a system described herein, and/or may be determined in by other methods. In some embodiments, a quantity of features (dimensions) represented by the low dimensional embedding may be predetermined (e.g., by the programmer at the creation of the present modular autoencoder model), determined based on output from prior layers of the neural network, adjusted by the user via the user interface associated with a system described herein, and/or determined by other methods.

In some embodiments, encoder decoder architecture 200 may be provided by and/or within one or more portions of a parameterized model such as one or more neural networks. However, it should be noted that even though a neural network, and/or encoder decoder architecture are mentioned throughout this specification, the operations described herein may be applied to different parameterized models (e.g., other machine learning models).

In some embodiments, the trained parameterized (multi modal) model comprises a large language model. In some embodiments, the trained parameterized model comprises a parietal space, a transformer, a multi attention head, an adapter, and/or other components. In some embodiments, the encoder comprises a first neural network, and the decoder comprises a second neural network. In some embodiments, the decoder comprises a transformer decoder.

Training of the parameterized model may be supervised or unsupervised. In some embodiments, training configures the parameterized model to learn a generic associativity of multi modal prompts, and once trained, to be deployed to output the zero-shot learning response to the multi modal prompt, without finetuning on new data types. The parameterized model is trained and/or otherwise configured to solve a task involving new multi modal inputs by finding a closest match to the multi modal prompt in an embedding space, and then assigning the multi modal prompt to a most relevant class based on a similarity of the multi modal prompt to the most relevant class. In some embodiments, one or more components of output engine 12 may be configured to train the parameterized model initially using input output training pairs and/or other information that provide an expected output based on a provided input, and/or other data.

In some embodiments, the parameterized model may comprise one or more individual algorithms (e.g., that form a LLM, a transformer, a neural network, an adapter, etc.). In some embodiments, an algorithm may be a machine learning algorithm. In some embodiments, the machine learning algorithm may be or include a neural network, classification tree, decision tree, support vector machine, or other model that is trained and configured to output a zero-shot learning response to a multi modal prompt. As an example, neural networks may be based on a large collection of neural units (or artificial neurons). Neural networks may loosely mimic the manner in which a biological brain works (e.g., via large clusters of biological neurons connected by axons). Each neural unit of a neural network may be simulated as being connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free flowing, with connections interacting in a more chaotic and complex fashion.

Returning to FIG. 1, input component 16 is configured to receive multi modal inputs from a user. The multi modal inputs comprise at least two different input modality types. The multi modal inputs having the at least two different input modality types comprise two or more of text, image, video, audio, signal, byte sequence, code, electromagnetic inputs, and/or other inputs. The electromagnetic inputs may comprise radiofrequency (RF) waves, microwaves, light waves, infrared radiation and/or other electromagnetic inputs, for example. As an example, the multi modal inputs having the at least two different input modality types may comprise a first input comprising text, and a second input comprising an image, a video, audio input, a signal, a byte sequence, code, an electromagnetic input, and/or other inputs. As another example, the multi modal inputs having the at least two different input modality types may comprise a first input comprising an image, a video, audio input, a signal, a byte sequence, code, or an electromagnetic input (and/or other inputs), and a second input comprising a different one of the image, video, audio input, signal, byte sequence, code, or electromagnetic input (and/or other inputs). In some embodiments, the at least two different input modality types comprises at least three (or more) different input modality types.

Encoding component 18 is configured to encode, with the encoder of the encoder decoder architecture (e.g., encoder 202 shown in FIG. 2), features of the multi modal inputs to form the multi modal prompt. The multi modal prompt comprises embedded features of mixed modalities from the at least two (or three or more) different input modality types. In some embodiments, input component 16 is configured to receive context information from the user, and encoding component 18 is configured encode the context information.

The encoder need not be retrained to encode different multimodal inputs from the user, and instead is configured to be reused. Usually there is an additional feature projection layer that merges the features from different encoder modalities or the decoder transformer is finetuned to adapt to the new features. Thus, the encoder is usually fixed, but the projector or transformer decoder changes to be able to interpret the new feature. In contrast, in the present system(s), an encoder is configured to encode both the features of the multi modal inputs to form the multi modal prompt and the context information to feed the decoder directly, without any added layers for combining features of different modes. In some embodiments, the encoder comprises multiple different pretrained encoders. These encoders are used to encode different inputs (e.g., inputs of different modalities) and bring the different inputs to a common embedding space (e.g., as described above) to form the multi modal prompt (that will then be provided to the decoder). These embedded features (which are included in the multi modal prompt) may be provided to a decoder transformer model (e.g., decoder 204 shown in FIG. 2), for example. The decoder transformer model, or part of it, is finetuned to adapt to new features (features it has not been trained on).

Finetuning means changing weights of a model via training. Using adapters, one can incorporate new modality by training less weight parameters and avoid training the whole model, which is costly. There are different cases one may need for finetuning: 1—a data domain change: this is to finetune the model to tackle different data tasks. For example, a model may be trained to classify car images, and then finetuned to classify airplanes images. 2—a modality addition: this is to finetune a model to interpret a new modality from a new encoder (audio, video, etc.). For 1—prompts may be used with examples to avoid a need for finetuning in this case, for example. For 2—adapters may be used (as described herein) to reduce finetuning costs and/or for other reasons.

The same encoder modules for different inputs feed the decoder transformer with encoded features through a context path and a prompt path. In the decoder's prompt path, prior models included added layers to combine two features (e.g., image and text), whereas in system 10, encoded features are provided to and/or otherwise form the decoder's multi modal prompt directly in a sequence of unified embedded features. Multiple encoder modules can be attached to the decoder transformer model as plugins depending on the application needs, for example.

The multi modal prompt comprises a single prompt, no matter how many different input modality types and/or what context information is included in inputs received from a user. Only key features of each of the multi modal inputs and/or context information are encoded to form the multi modal prompt such that the multi modal prompt is relatively low dimensional compared to a dimensionality of any of the multi modal inputs and/or context information. The key features are “key” because they are more predictive than other features of correct outputs during training of the parameterized model. The multi modal prompt allows more flexible and compact representation of tasks to the model. This also avoids multiple iterative runs of the model. For example, it is easier to express a task with a text and image, rather than multiple iterations of the model with multiple text prompts describing the image.

Decoding component 20 is configured to provide the prompt to a decoder (e.g., decoder 204 shown in FIG. 2) of the encoder decoder architecture to cause the decoder to output the response based on the multi modal prompt. The decoder is configured to output the response without prior training on at least one of the multi modal inputs received from the user. In some embodiments, decoding component 20 is configured to cause the decoder to output the response based on the multi modal prompt and encoded context information, and/or other information.

As described above, in some embodiments, the decoder comprises a transformer decoder. Given a new input modality feature, the transformer decoder is finetuned for a task that uses the new input modality of the feature, such that the parameterized model adapts how to best project input features into an internal embedding space of the parameterized model. In some embodiments, the decoder comprises a multi-attention head configured to receive the multi modal prompt and guide generation of the output response. In some embodiments, encoding the features of the multi modal inputs to form the multi modal prompt and outputting the zero-shot learning response to the multi modal prompt decouples a training dataset (e.g., the input output training pairs described above) from application of the parameterized model such that the parameterized model is trained to have generic associativity capabilities instead of outputting responses based a particular training dataset.

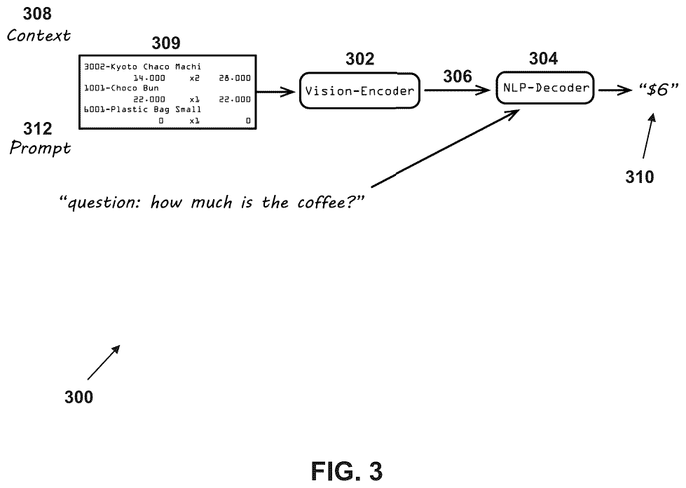

By way of a non-limiting example, FIG. 3 illustrates a base example of a vision based transformer model 300 (e.g., a trained parameterized (multi modal) model) that includes an encoder 302 (a vision encoder in this example) and a decoder 304 (an NLP decoder in this example). Encoder 302 projects inputs into embeddings, which are provided 306 to decoder 304. The encoder 302 input comprises context 308 (an image 309 of a receipt in this example) and/or other information. Decoder 304 is configured to generate an output 310 (“$6” in this example). Prompting (via prompt 312) is performed by providing the multi modal model 300 with text commands 314 (e.g., “question: how much is the coffee?” in this example). Prompt 312 is configured to guide decoder 304 to generate output 310 according to prompt 312.

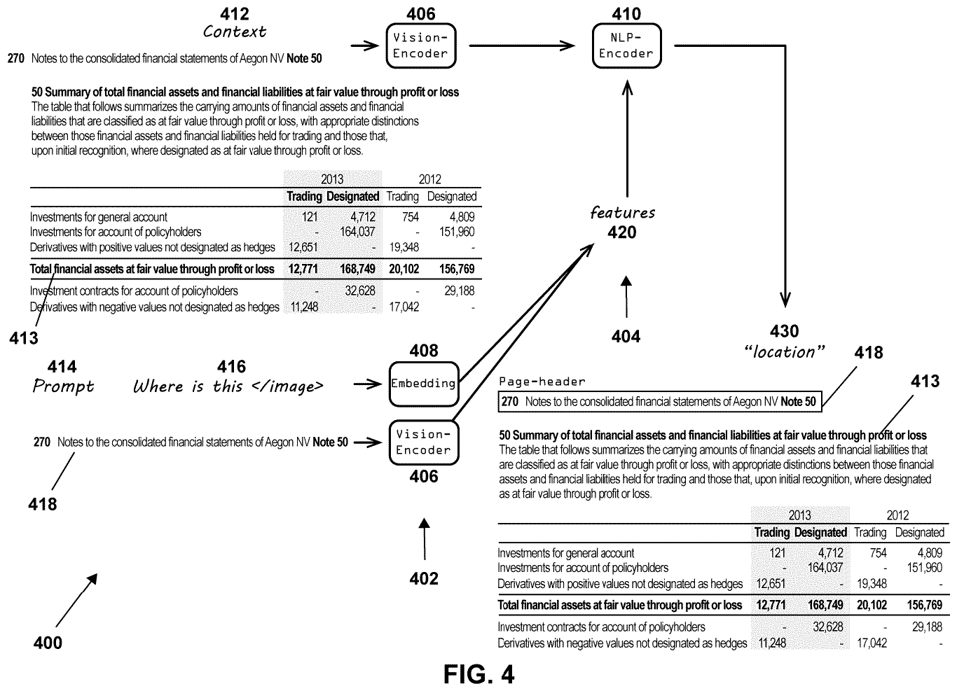

FIG. 4 illustrates an enhanced multi modal model 400 (e.g., enhanced relative to model 300 shown in FIG. 3). Model 400 (e.g., another example of a trained parameterized (multi modal) model) includes an encoder 402 and a decoder 404. Encoder 402 includes a vision encoder 406, and an embedding portion 408. Decoder 404 comprises an NLP decoder 410. Note that this is just one possible embodiment. Encoder 402 and/or decoder 404 may comprise more or less, or alternate, components (e.g., for multi modal inputs of different modalities than images and/or text) that the ones shown in FIG. 4 that still allow system 10 (FIG. 1) to function as described herein. As shown in FIG. 4, context 412 comprising an image 413 of a portion of a document is provided to vision encoder 406. Prompt 414 is also provided. In this example, prompt 414 comprises a text portion 416 (e.g., a first mode) that asks “where is this” and an image portion 418 (e.g., a second mode) that provides a portion of an image that the user is looking for. Encoder 402 is configured to encode or embed features 420 of prompt 414 to form a multimodal prompt that is provided to decoder 404. Decoder 404 outputs image 413 with the location 430 of image portion 418 identified.

Putting the example shown in FIG. 4 in the context of system 10 shown in FIG. 1, input component 16 is configured to receive the multi modal inputs (e.g., text portion 416 (e.g., a first mode) and image portion 418 (e.g., a second mode)) from a user. The multi modal inputs comprise at least two different input modality types. The multi modal inputs may also have different and/or additional input modality types such as video, audio, signal, byte sequence, code, electromagnetic inputs, and/or other inputs. Encoding component 18 is configured to cause encoder 402 to encode, features 420 of the multi modal inputs to form the multi modal prompt. The multi modal prompt comprises embedded features of mixed modalities from the two (in this example) different input modality types. Input component 16 is also configured to receive context 412 from the user, and encoding component 18 is configured cause encoder 402 to encode context 412.

As described above, encoder 402 need not be retrained to encode different multimodal inputs from the user, and instead is configured to be reused. Encoder 402 is configured to encode the features of the multi modal inputs (e.g., 416 and 418 in this example) to form the multi modal prompt and context 412 to feed decoder 404 directly, without any added layers for combining features of different modes. In some embodiments, as shown in FIG. 4, encoder 402 comprises multiple different pretrained encoders (e.g., 406, 408). These encoders are used to encode different inputs (e.g., inputs of different modalities such as 416 and 418) and bring the different inputs to a common embedding space to form the multi modal prompt. These embedded features (which are included in the multi modal prompt) may be provided to a decoder transformer model (e.g., NLP decoder 410 shown in FIG. 4), for example. The decoder transformer model is finetuned to adapt to new features (features it has not been trained on). The same encoder modules for different inputs feed the decoder transformer with encoded features through a context path (e.g., the top most path in FIG. 4) and a prompt path (e.g., the combination of the path that extends from 416 and 418 in FIG. 4).

Decoding component 20 (FIG. 1) is configured to provide the prompt (e.g., comprising embedded features 420) to decoder 404 to cause decoder 404 to output the response based on the multi modal prompt. The decoder is configured to output the response (e.g., location 430 in this example) without prior training on at least one of the multi modal inputs (e.g., 416 or 418 in this example) received from the user.

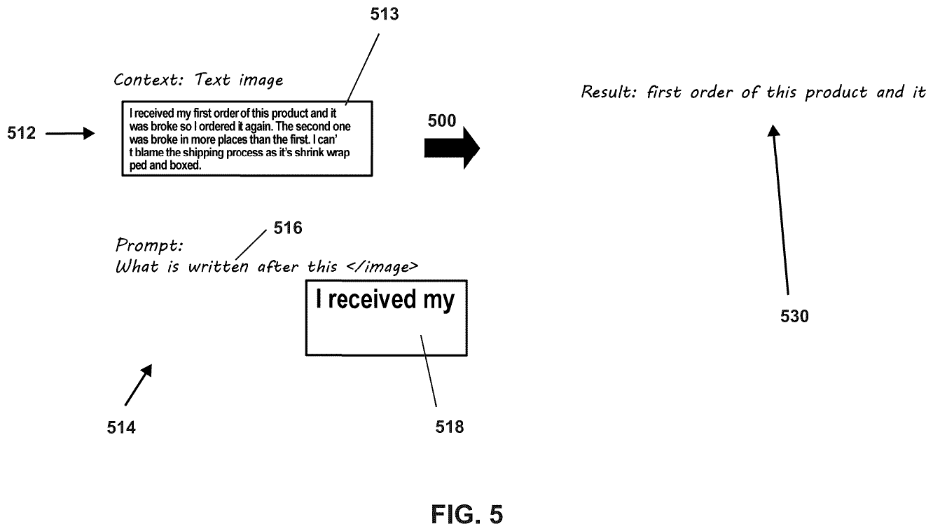

FIG. 5 illustrates a first example task that may be performed by system 10 (FIG. 1). Context 512 comprising an image 513 of a portion of text is received from a user. Prompt 514 is also received. Prompt 514 comprises a text portion 516 (e.g., a first mode) that asks “what is written after this” and an image portion 518 (e.g., a second mode) that provides an image text that the user is looking for. System 10 outputs (output 500) a textual answer 530 with the text that follows “I received my” identified. In this example, the text that follows “I received my” is “first order of this product and it”. Output 500 is an example of a zero-shot learning response to a multi modal prompt using a trained parameterized model provided by system 10.

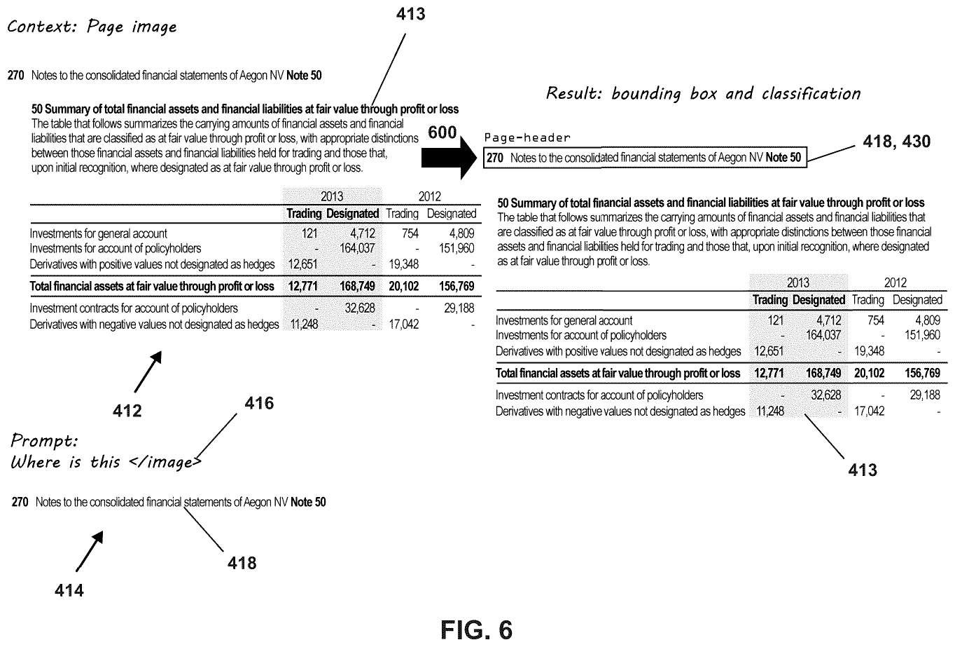

FIG. 6 illustrates a second example task that may be performed by system 10 (FIG. 1). The example shown in FIG. 6 corresponds to the example shown in FIG. 4 and described above. Context 412 comprising an image 413 of a portion of a document is received from a user. Prompt 414 is also received. As in FIG. 4, prompt 414 comprises a text portion 416 (e.g., a first mode) that asks “where is this” and an image portion 418 (e.g., a second mode) that provides a portion of an image that the user is looking for. System 10 outputs (output 600) image 413 with the location 430 of image portion 418 identified. In this example, location 430 is indicated by a bounding box that surrounds portion 418 of image 413. Output 600 is another example of a zero-shot learning response to a multi modal prompt using a trained parameterized model provided by system 10. The model is configured to generate pixel positions: top left corner (x, y), width and height of a rectangle in this example. This rectangle (e.g., the bounding box described above) highlights a region of the document (e.g., the document shown in image 413). The model also outputs a classification of what document component that rectangle represents: title, header, footer, paragraph, etc. (e.g., a header in this example).

Note that the examples shown in FIG. 5 and FIG. 6 are limited to text and image modalities, but may other combinations of input (and/or output) modalities are possible (e.g., input modalities such as but not limited to video, audio, signal, byte sequence, code, electromagnetic, and/or other inputs.

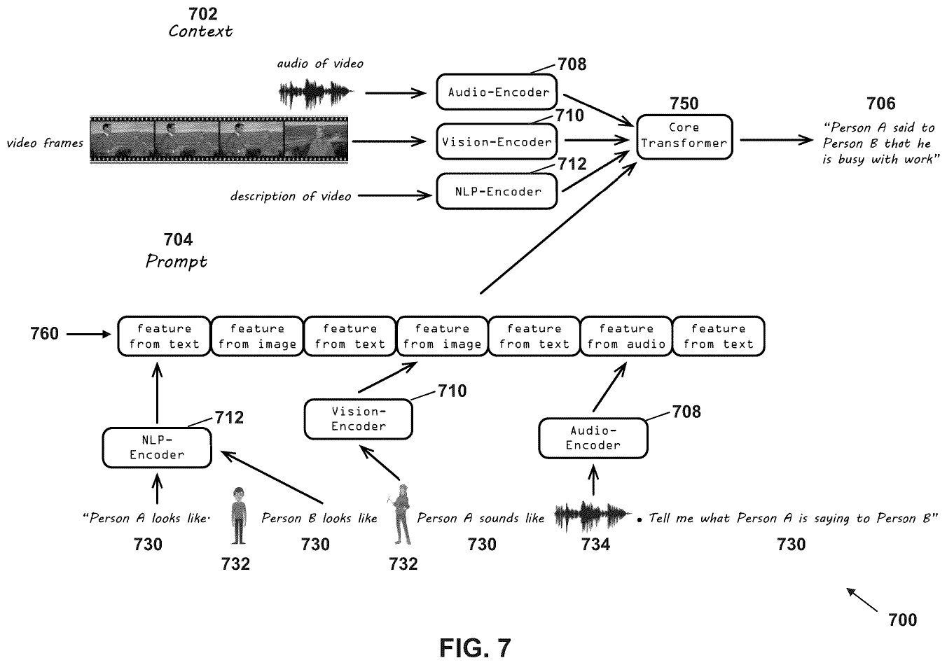

For example, FIG. 7 illustrates another embodiment of an enhanced multi modal model 700 (e.g., another example of a trained parameterized (multi modal) model). FIG. 7 illustrates using multi modal context 702, combined with multi-modal prompt 704 to achieve a complex task zero shot (see output 706), and reusing encoders (708, 710, and 712). In this example, context 702 comprises video frames 720 (e.g., a first mode), audio 722 (e.g., a second mode) associated with video frames 720, and a written description 724 (e.g., a third mode) of video frames 720. Prompt 704 comprises text portions 730 (e.g., a first mode), image portions 732 (e.g., a second mode), and an audio portion 734 (e.g., a third mode). Prompt 704 describes what person A looks by providing an image, describes what person B looks like by providing an image, and describes what person A sounds like by providing audio associated with person A, then using text, states “Tell me what person A is saying to person B.”

Model 700 includes encoders 708 (e.g., an audio encoder), 710 (e.g., a vision encoder), and 712 (e.g., an NLP encoder), and a decoder 750 (e.g., a core transformer in this example). Note that this is just one possible embodiment. The encoder(s) and/or decoder may comprise more or less, or alternate, components (e.g., for multi modal inputs of different modalities than audio, video, images, and/or text) that the ones shown in FIG. 7 that still allow system 10 (FIG. 1) to function as described herein. As shown in FIG. 7, different appropriate portions of context 702 and prompt 704 are provided to corresponding encoders 708, 710, and 712. Key features 760 of prompt 704 are embedded to form a multimodal prompt that is provided to decoder 750. In this example, encoder 750 outputs (e.g., output 706) a textual statement that “person A said to person B that he is busy with work.”

Putting the example shown in FIG. 4 in the context of system 10 shown in FIG. 1, input component 16 is configured to receive the multi modal inputs from a user. The multi modal inputs comprise at least three different input modality types in this example. Encoding component 18 is configured to cause the encoding of the key features of the multi modal inputs to form the multi modal prompt. The multi modal prompt comprises embedded features of mixed modalities from the three (in this example) different input modality types. Input component 16 is also configured to receive context from the user, and encoding component 18 is configured cause encoding of the context.

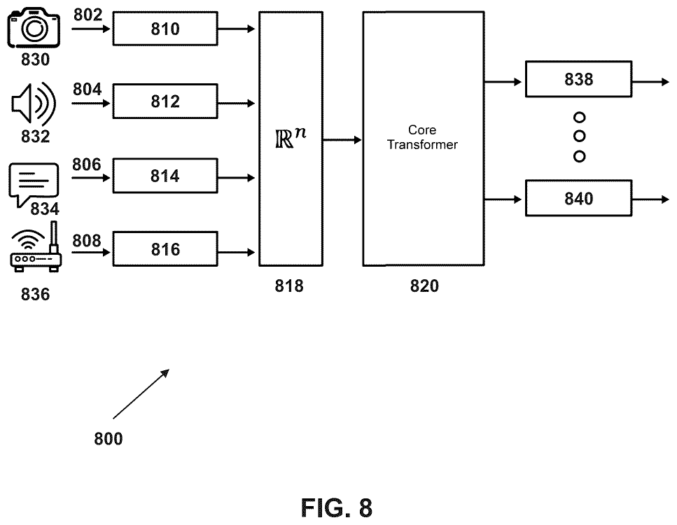

FIG. 8-12 illustrate additional details related to one or more of the example (trained parameterized) multi modal models illustrated in prior figures. These models may be generated, executed, and/or otherwise utilized by controller 14 (and/or one or more of the components of controller 14) as shown in FIG. 1 and described above.

FIG. 8 illustrates an embodiment of a multi modal model 800 (e.g., a trained parameterized model similar to and/or the same as models 300, 400, and/or 700 shown in FIGS. 3, 4, and/or 7, and/or a portion of one or more of these models) comprising encoders 802, 804, 806, and 808; corresponding embeddings 810, 812, 814, and 816; a parietal space 818; a transformer 820; and/or other components. FIG. 8 illustrates different potential types of inputs 830, 832, 834, and 836; and corresponding outputs 838 . . . 840. FIG. 8 illustrates a mix of encoders 802-808 corresponding to different types or modes of input 830-836 (see various examples of encoders described herein). The encoders 802-808 project inputs 830-836 into embeddings 810-816, which are used to generate a multi modal prompt, which is provided to transformer 820 (decoder). An embedding 810-816 may be a relatively lower dimensional numerical or other representation of one or more inputs 830-836, received from a relatively high-dimensional space. Encoders for different modalities are generally pre-trained separately. As a result, the embeddings generated by these encoders lie in different space. Model 800 is configured to fuse these embeddings by first bringing them to a common space, which can be called parietal space 818. For example, encoder(s) 802-808 may be configured to encode features of multi modal inputs 830-836 to form a low dimensional encoding or embedding such as a multi modal prompt in parietal space 818 (e.g., the low dimensional embedding space).

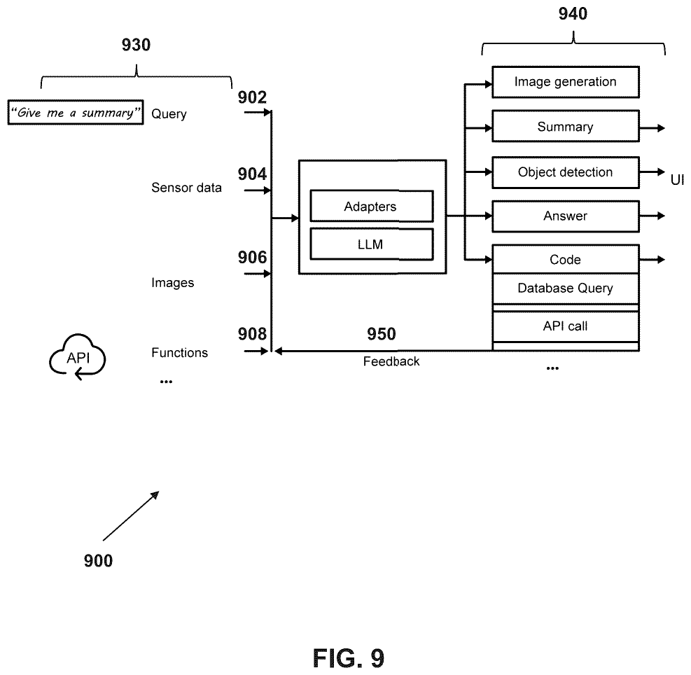

FIG. 9 illustrates an embodiment of a multi modal model 900 (e.g., a trained parameterized model similar to and/or the same as models 300, 400, 700, and/or 800 shown in FIGS. 3, 4, 7, and/or 8, and/or a portion of one or more of these models) comprising encoders 902, 904, 906, and 908; a large language model (LLM); adapter(s); and/or other components. FIG. 9 illustrates different potential types of inputs 930; and corresponding outputs 940 (e.g., at least some of which may be provided to a user via a user interface (UI) in this example).

An adapter is configured to enhance or adjust model 900 for new inputs, tasks, outputs, etc., without (or without significantly) modifying a structure of model 900. An adapter is usually smaller (e.g., has less training parameters) than its associated model (model 900 in this example). One or more adapters may be associated with encoders, decoders, LLMs, transformers, etc. Adapters facilitate learning and fine-tuning for specific tasks with (relatively) little additional training data and computational resources, compared to retraining the entire model 900. An adapter may comprise a neural network, for example, and/or other structures. An adapter may be modular. An adapter may be associated with a certain layer of model 900, positioned between layers, and/or have a different arrangement. The parameters of an adapter may be adjusted without having to adjust other parameters of model 900.

In some embodiments, encoding component 18, or encoding component 18 in combination with input component 16 and/or decoding component 20 (e.g., controller 14)-all illustrated in FIG. 1—is/are configured such that at least a portion 950 of output 940 by (the trained parameterized) model 900 is provided as feedback to the trained parameterized model. The portion 950 of output 940 provided as feedback may be used as input 930 for subsequent responses by model 900. In some embodiments, the feedback is configured to iteratively refine input 930 to model 900, while model 900 itself remains the same. In some embodiments, the feedback is used as input 930 that is separate from, and in addition to, the multi modal inputs (e.g., the “Query”, “Sensor Data”, “Images”, and “Functions” in this example) from a user and/or other sources. This contrasts with a recurrent neural network (RNN), for example, in which additional data is used to retrain the RNN itself (so that the RNN is changed from what it was before).

In some embodiments, as shown in this example, the feedback comprises code, the output of executed code, and/or other feedback. In FIG. 9, the code may cause an additional database query, an (or an additional) API call, and/or other actions that may generate additional input for model 900. This may refine the UI output provided by model 900. The feedback loop shown in FIG. 9 (i.e., providing the portion 950 of output 940 as feedback) may be repeated any number of times to iteratively refine the output from model 900. The number of repetitions may be set by a user, determined automatically (e.g., by controller 14 shown in FIG. 1) based on a comparison of output 940 to a threshold, and/or by other methods.

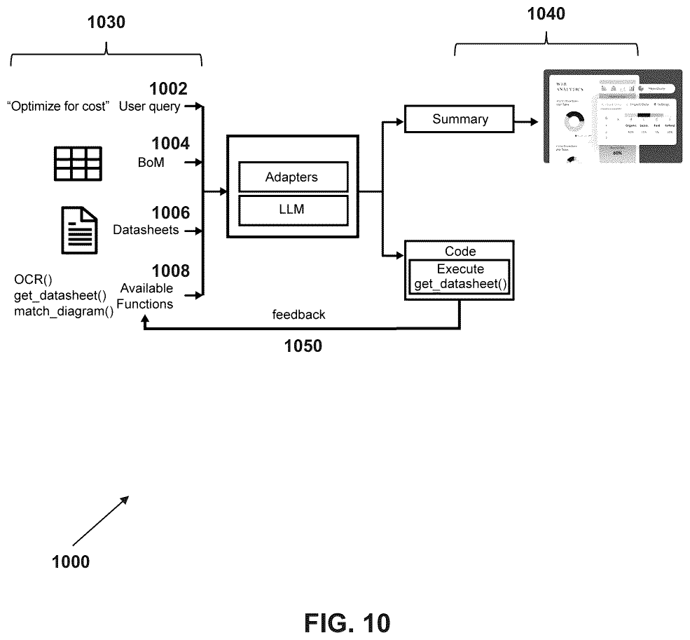

As another example, in FIG. 10, a similar portion 1050 of output 1040 is provided as feedback for model 1000—e.g., a trained parameterized model similar to and/or the same as models 300, 400, 700, 800, and/or 900 shown in FIGS. 3, 4, and/or 7-9 (and/or a portion of one or more of these models) comprising encoders 1002, 1004, 1006, and 1008; a large language model (LLM); adapter(s); and/or other components. The portion 1050 of output 1040 provided as feedback may be used as input 1030 for subsequent responses by model 1000. In some embodiments, the feedback is configured to iteratively refine input 1030 to model 1000, while model 1000 itself again remains the same. In some embodiments, as shown in this example, the feedback comprises code, the output of executed code, and/or other feedback. In FIG. 10, the code may cause system 10 (FIG. 1) to obtain one or more additional datasheets used for optimizing a certain part requested by a user for cost (see the user query in FIG. 10). A bill of materials (BOM), one or more datasheets, available optimization and/or other functions, and/or other inputs 1030 may be provided to model 1000 for cost optimization. The feedback loop shown in FIG. 10 (i.e., providing the portion 1050 of output 1040 as feedback) may be repeated any number of times to iteratively refine the output (e.g., a summary display of cost optimized components of a certain part desired by a user in this example) from model 1000. For example, if a cost threshold for the certain part is not reached based on the information in one or more first datasheets (e.g., which may describe various potential components of the certain part and their costs), one or more second datasheets with additional and/or other information may be obtained (and this process may be repeated) in an effort to optimize components of the certain part according to the cost threshold. In this example, once an optimal set of components for the certain part is eventually determined, the summary may be displayed.

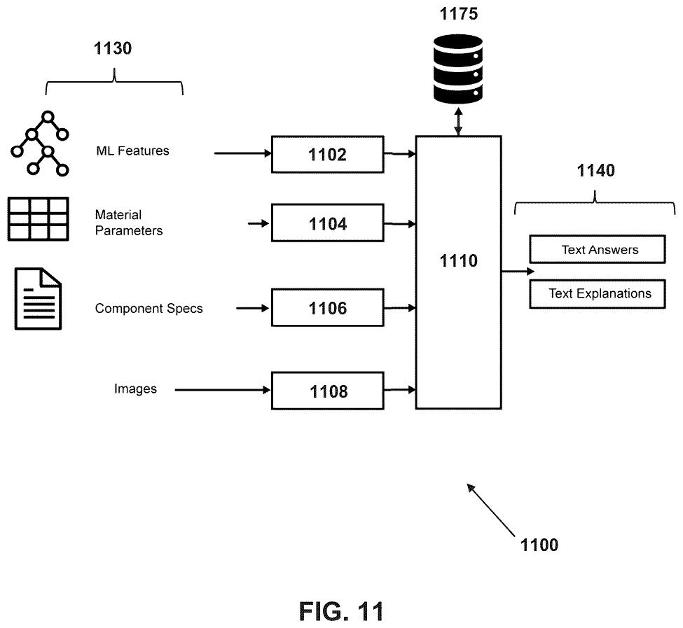

FIG. 11 illustrates an embodiment of a multi modal model 1100 (e.g., a trained parameterized model similar to and/or the same as models 300, 400, 700, 800, 900, and/or 1000 shown in FIGS. 3, 4, and/or 7-10, and/or a portion of one or more of these models) comprising adapters 1102, 1104 (e.g. a table adapter), 1106 (e.g., a text adapter), and 1108 (e.g., a vision adapter); a transformer 1110 (or decoder); and/or other components. Note in this example that one or more adapters 1102-1108 may be changed to one or more encoders, one or more encoders may be added to model 1100, and/or other architectures may be used. FIG. 11 illustrates different potential mode (e.g., multi modal) inputs 1130 (e.g., machine learning (ML) features, a table or spreadsheet with material parameters, documents describing component specs, and images in this example) to the adapters; and corresponding outputs 1140 such as text answers and text explanations (e.g., at least some of which may again be provided via a user interface in this example).

As shown in FIG. 11, in some embodiments, a trained parameterized (multi modal) model such as model 1100 (e.g., as generated, executed and/or otherwise utilized by one or more of the components of controller 14 shown in FIG. 1) may be configured to store embedded features in a feature database 1175. The embedded and stored features may be of mixed modalities. The embedded features may be from current and/or prior prompts. This creates a library of features, to be used in combination with later prompts and/or context information to output responses (e.g., outputs 1140). Feature database 1175 may be similar to and/or the same as data store 30 shown in FIG. 1, for example, In some embodiments, feature database 1175 may be part of external resources 46 (e.g., an online database), for example.

Feature database 1175 may be configured to store features in different ways, as appropriate for a given application. For example, feature database 1175 may be configured to store a tuple with an image, text, and a vector. The vector may be an encoder's output embedding of the image or text, for example. Without being able to list every possible potential feature, in some embodiments, features may comprise or represent properties or characteristics of various inputs, individual words, phrases, syntactic structures, semantic roles, a type of word (e.g., noun, verb, adjective, etc.), punctuation, edges, corners, textures, and/or color histograms of images, labels and/or values from a table of data, raw features, transformed features, learned features, and/or other features.

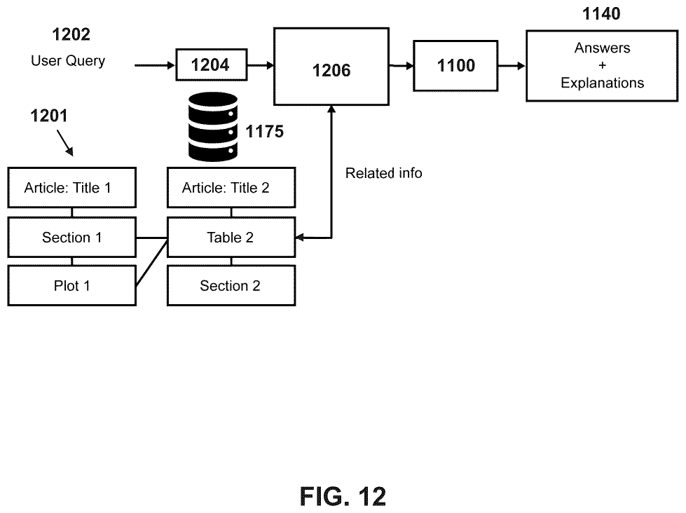

In some embodiments, as shown in FIG. 12, using stored features from database 1175 to output responses (outputs 1140) to later prompts comprises performing a hierarchical feature search 1201 of feature database 1175 and/or other (internal to system 10 or external) databases to efficiently identify features and/or other information related to a user query 1202 that can be provided with an embedding 1204 as augmented input 1206 to (trained parameterized) model 1100. (Note that data can also be stored to database 1175 in this example too.) In this example, hierarchical feature search 1201 comprises first searching through titles of various articles to find a relevant article or articles, and then searching sections, plots, and/or tables of the article(s) for related features and/or other information. In some embodiments, model 1100 (and the other similar modes described herein) is configured to solve a task involving new multi modal inputs by finding a closest match to a multi modal prompt in an embedding space, based on a result of hierarchical feature search 1201, context information, and/or other information, and then assign the multi modal prompt to a most relevant class based on a similarity of the multi modal prompt to the most relevant class.

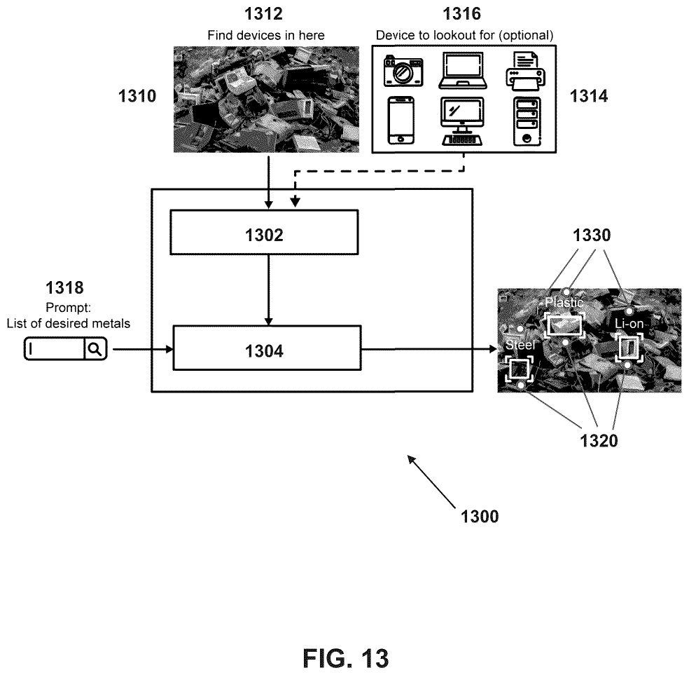

FIG. 13 illustrates an example use case for system 10 (FIG. 1) and one or more of the example multi modal models illustrated in prior figures. In FIG. 13, system 10 is asked to identify certain devices, and materials in those devices, in a picture of discarded devices. FIG. 13 illustrates an embodiment of a multi modal model 1300 (similar to and/or the same as models 300, 400, 700, 800, 900, 1000, and/or 1100 shown in FIGS. 3, 4, and/or 7-12) comprising an encoder 1302 (e.g., comprising a detection feature extractor in this example) and a decoder 1304 (e.g., a NLP decoder in this example). In this example, the input comprises an image 1310 of a pile of various discarded devices, a text command 1312 to find devices in image 1310, optional images 1314 and/or descriptions 1316 of devices to look out for, and textual entry of a list 1318 of desired metals in the devices. This information is used by model 1300 to generate a zero shot understanding of the scene in image 1310. The output comprises the image 1310 of the pile of discarded devices with bounding boxes 1320 surrounding identified devices of interest in various locations, with a neighboring listing 1330 of materials in the devices. Context that may be provided with the inputs includes product specifications for the devices of interest, features of image 1310, and/or other information.

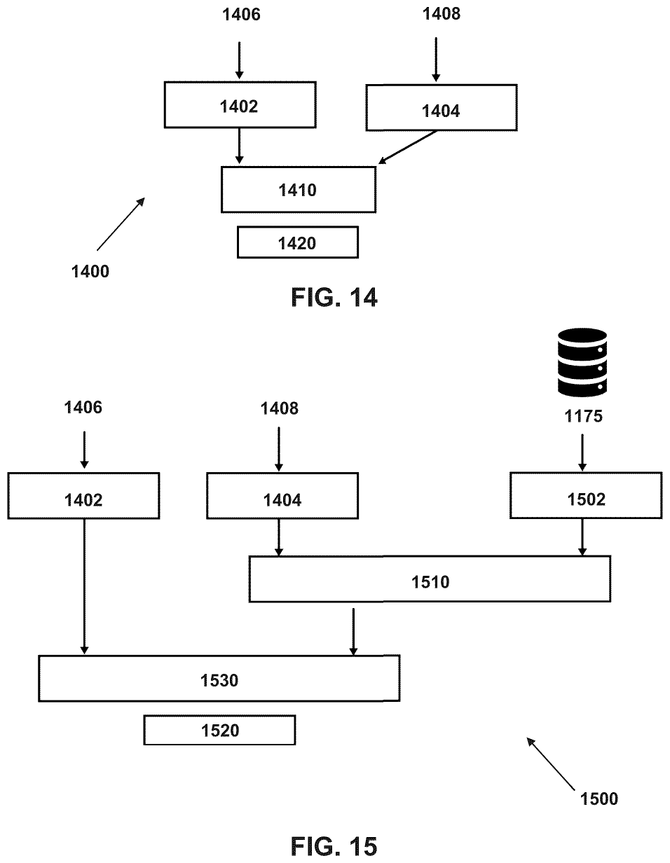

FIG. 14 illustrates using one or more of the example multi modal models illustrated in prior figures to make predictions and/or otherwise generate outputs. FIG. 15 illustrates using one or more of the example multi modal models illustrated in prior figures, in combination with information from a features database, in contrast to what is shown in FIG. 14. FIGS. 14 and 15 illustrate embodiments of trained parameterized multi modal models 1400 and 1500, respectively (e.g., similar to and/or the same as models 300, 400, 700, 800, 900, 1000, 1100, and/or 1300 shown in FIGS. 3, 4, and/or 7-13). FIG. 14 illustrates encoders 1402 (e.g., a vision transformer encoder) and 1404 (e.g., a textual encoder) associated with image and textual inputs 1406 and 1408, respectively. In this example, various encoded features are provided for matrix multiplication 1410 to generate a multimodal prompt, to be used by model 1400 to generate outputs 1420 (e.g., predictions and/or other responses). In some embodiments, a feature projection layer is usually a feedforward linear layers, which can comprise matrix multiplication operations. FIG. 14 illustrates combining multimodal encoded features using a projection layer in this example.

FIG. 15 illustrates the same inputs 1406 and 1408, and encoders 1402 and 1404, but now used in combination with features of images (and/or the images themselves) from feature database 1175 and a corresponding encoder 1502 (e.g., another vision transformer encoder). In this example, various encoded features from encoders 1404 and 1502 are provided for matrix multiplication 1510. Output from matrix multiplication 1510 is provided together with encoded features from encoder 1402 for a second matrix multiplication 1530. Output from second matrix multiplication 1530 is used to generate a multimodal prompt, to be used by model 1500 to generate outputs 1520 (e.g., predictions and/or other responses). Including matrix multiplication operations like these (e.g., shown in FIG. 14 and FIG. 15), in combination with data stored in feature database 1175 can increase the accuracy of the outputs from the models described herein, among other advantages. FIG. 14 and FIG. 15 show that features can be combined using a sequence of projection layers, comprising linear layers which include matrix multiplication operations.

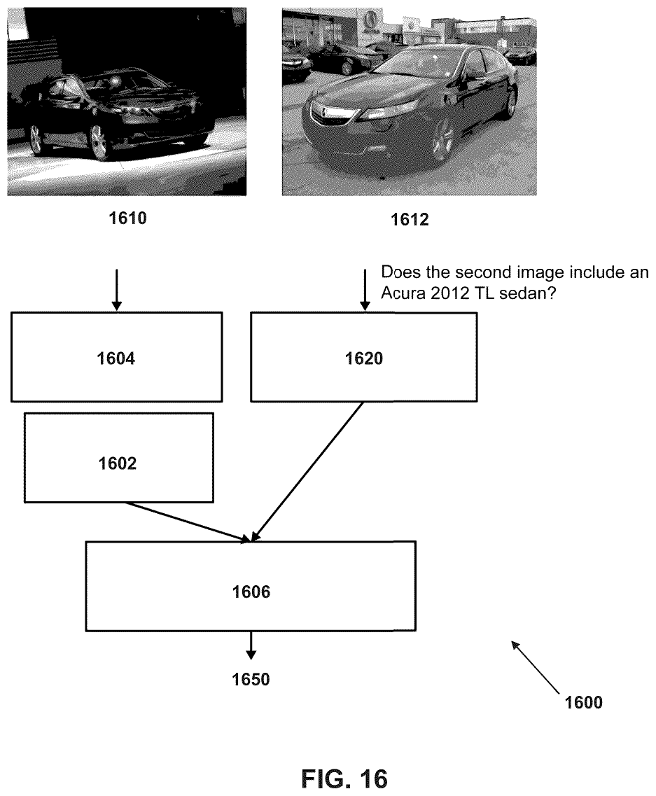

FIG. 16 illustrates another example use case for one or more of the example trained parameterized multi modal models illustrated in prior figures. FIG. 16 illustrates an embodiment of a trained parameterized multi modal model 1600 (e.g., similar to and/or the same as models 300, 400, 700, 800, 900, 1000, 1100, 1300, 1400, and/or 1500 shown in FIGS. 3, 4, and/or 7-15) comprising a projector 1602. In this example, a model pre-trained for text processing (see blocks 1606, 1620 described below) is used. To add image processing capability, a projector layer (e.g., one or more linear layers) may be added and trained to convert image features into the features that block 1606 can interpret. An alternative to using a projection layer is to add adapter modules to block 1606 and finetune it for image understanding, for example. FIG. 16 illustrates a mix of encoders 1604 (see various examples of encoders described herein) and a decoder 1606. Mix of encoders 1604 projects, using projector 1602 in this example, inputs into embeddings, which are provided (following the arrows in FIG. 16) to decoder 1606. In this example, the input comprises an image 1610 of an example of an Acura 2012 TL sedan, a second image 1612 showing a second sedan, and text asking “does the second image include an Acura 2012 TL sedan?”. This question is converted to a textual embedding 1620, and used together with the output from projector 1602 as a multi modal prompt. Decoder 1606 is configured to generate an output 1650 (“yes” in this example). In some embodiments, decoder 1606 comprises a transformer decoder. Given a new input modality feature, the transformer decoder is finetuned for a task that uses the new input modality of the feature, such that the parameterized model 1600 adapts how to best project input features into an internal embedding space of the model.

Returning to FIG. 1, it should be noted that in some embodiments, output engine 12 may be configured such that in the above mentioned operations of controller 14, and input from users and/or sources of information inside or outside system 10, may be processed by controller 14 through a variety of formats, including clicks, touches, uploads, downloads, etc., The illustrated components (e.g., controller 14, API server 26, web server 28, data store 30, and cache server 32) of output engine 12 are depicted as discrete functional blocks, but embodiments are not limited to systems in which the functionality described herein is organized as illustrated by FIG. 1. The functionality provided by each of the components of output engine 12 may be provided by software or hardware modules that are differently organized than is presently depicted, for example such software or hardware may be intermingled, broken up, distributed (e.g. within a data center or geographically), or otherwise differently organized. The functionality described herein may be provided by one or more processors of one or more computers executing code stored on a tangible, non-transitory, machine readable medium.

FIG. 17 is a diagram that illustrates an exemplary computer system 1700 in accordance with embodiments of the present system. Various portions of systems and methods described herein may include or be executed on one or more computer systems the same as or similar to computer system 1700. For example, output engine 12, mobile user device 34, mobile user device 36, desktop user device 38, external resources 46 and/or other components of system 10 (FIG. 1) may be and/or include one more computer systems the same as or similar to computer system 1700. Further, processes, modules, processor components, and/or other components of system 10 described herein may be executed by one or more processing systems similar to and/or the same as that of computer system 1700.

Computer system 1700 may include one or more processors (e.g., processors 1710a-1710n) coupled to system memory 1720, an input/output I/O device interface 1730, and a network interface 1740 via an input/output (I/O) interface 1750. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 1700. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1720). Computer system 1700 may be a uni-processor system including one processor (e.g., processor 1710a), or a multi-processor system including any number of suitable processors (e.g., 1710a-1710n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 1700 may include a plurality of computing devices (e.g., distributed computer systems) to implement various processing functions.

I/O device interface 1730 may provide an interface for connection of one or more I/O devices 1760 to computer system 1700. I/O devices may include devices that receive input (e.g., from a user) or output information (e.g., to a user). I/O devices 1760 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1760 may be connected to computer system 1700 through a wired or wireless connection. I/O devices 1760 may be connected to computer system 1700 from a remote location. I/O devices 1760 located on a remote computer system, for example, may be connected to computer system 1700 via a network N and network interface 1740.

Network interface 1740 may include a network adapter that provides for connection of computer system 1700 to network N. Network interface May 1740 may facilitate data exchange between computer system 1700 and other devices connected to the network. Network interface 1740 may support wired or wireless communication. The network may include an electronic communication network, such as the Internet, a local area network (LAN), a wide area network (WAN), a cellular communications network, or the like.

System memory 1720 may be configured to store program instructions 1770 or data 1780. Program instructions 1770 may be executable by a processor (e.g., one or more of processors 1710a-1710n) to implement one or more embodiments of the present techniques. Instructions 1770 may include modules and/or components (e.g., components 16, 18, and/or 20 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1720 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1720 may include a non-transitory computer readable storage medium that may have program instructions stored thereon that are executable by a computer processor (e.g., one or more of processors 1710a-1710n) to cause the subject matter and the functional operations described herein. A memory (e.g., system memory 1720) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1750 may be configured to coordinate I/O traffic between processors 1710a-1710n, system memory 1720, network interface 1740, I/O devices 1760, and/or other peripheral devices. I/O interface 1750 may perform protocol, timing, or other data transformations to convert data signals from one component (e.g., system memory 1720) into a format suitable for use by another component (e.g., processors 1710a-1710n). I/O interface 1750 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1700 or multiple computer systems 1700 configured to host different portions or instances of embodiments. Multiple computer systems 1700 may provide for parallel or sequential processing/execution of one or more portions of the techniques described herein.

Those skilled in the art will appreciate that computer system 1700 is merely illustrative and is not intended to limit the scope of the techniques described herein. Computer system 1700 may include any combination of devices or software that may perform or otherwise provide for the performance of the techniques described herein. For example, computer system 1700 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 1700 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1700 may be transmitted to computer system 1700 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

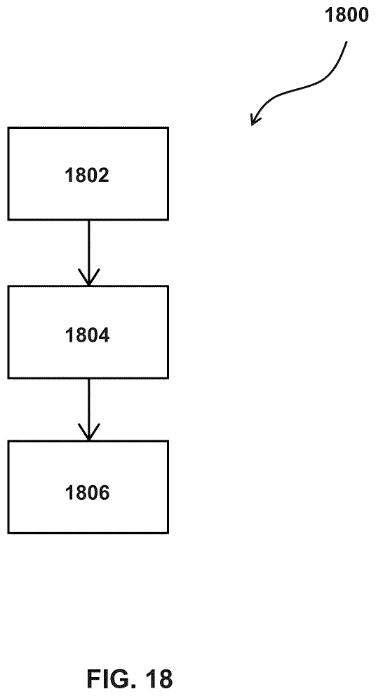

FIG. 18 is a flowchart of a method 1800 for outputting a zero-shot learning response to a multi modal prompt using a trained parameterized model. The trained parameterized model comprises encoder decoder architecture. In some embodiments, the trained parameterized model comprises a large language model. In some embodiments, the trained parameterized model comprises a transformer, one or more neural networks (e.g., an encoder comprising a first neural network, and a decoder comprising a second neural network), a parietal space, one or more adapters, and/or other components.

Method 1800 may be performed with some embodiments of system 10 (FIG. 1), computer system 1700 (FIG. 17), and/or other components discussed above. Method 1800 may include additional operations that are not described, and/or may not include one or more of the operations described below. The operations of method 1800 may be performed in any order that facilitates using multi modal prompts for zero-shot mixed tasks, as described herein.

Method 1800 begins with operation 1802, comprising receiving multi modal inputs from a user. The multi modal inputs comprise at least two different input modality types. The multi modal inputs having the at least two different input modality types comprise two or more of text, image, video, audio, signal, byte sequence, code, electromagnetic inputs, and/or other inputs. The electromagnetic inputs may comprise radiofrequency (RF) waves, microwaves, light waves, infrared radiation and/or other electromagnetic inputs, for example. As an example, the multi modal inputs having the at least two different input modality types may comprise a first input comprising text, and a second input comprising an image, a video, audio input, a signal, a byte sequence, code, an electromagnetic input, and/or other inputs. As another example, the multi modal inputs having the at least two different input modality types may comprise a first input comprising an image, a video, audio input, a signal, a byte sequence, code, or an electromagnetic input (and/or other inputs), and a second input comprising a different one of the image, video, audio input, signal, byte sequence, code, or electromagnetic input (and/or other inputs). In some embodiments, the at least two different input modality types comprises at least three (or more) different input modality types.

Method 1800 continues with operation 1804, comprising encoding, with an encoder of the encoder decoder architecture, features of the multi modal inputs to form the multi modal prompt. The multi modal prompt comprises embedded features of mixed modalities from the at least two (or three or more) different input modality types. In some embodiments, operation 1804 comprises receiving context information from the user, and encoding the context information. The encoder need not be retrained to encode different multimodal inputs from the user, and instead is configured to be reused. The encoder is configured to encode both the features of the multi modal inputs to form the multi modal prompt and the context information to feed the decoder directly, without any added layers for combining features of different modes.

The multi modal prompt comprises a single prompt, no matter how many different input modality types and/or what context information is included in inputs received from a user. Only key features of each of the multi modal inputs and/or context information are encoded to form the multi modal prompt such that the multi modal prompt is relatively low dimensional compared to a dimensionality of any of the multi modal inputs and/or context information. The key features are “key” because they are more predictive than other features of correct outputs during training of the parameterized model.

Training of the parameterized model may be supervised or unsupervised. In some embodiments, training configures the parameterized model to learn a generic associativity of multi modal prompts, and once trained, to be deployed to output the zero-shot learning response to the multi modal prompt, without finetuning on new data types. The parameterized model is trained and/or otherwise configured to solve a task involving new multi modal inputs by finding a closest match to the multi modal prompt in an embedding space, and then assigning the multi modal prompt to a most relevant class based on a similarity of the multi modal prompt to the most relevant class.

Operation 1806 comprises providing the prompt to a decoder of the encoder decoder architecture to cause the decoder to output the response based on the multi modal prompt. The decoder is configured to output the response without prior training on at least one of the multi modal inputs received from the user. In some embodiments, operation 1806 includes causing the decoder to output the response based on the multi modal prompt and encoded context information.

In some embodiments, the decoder comprises a transformer decoder. Given a new input modality feature, the transformer decoder is finetuned for a task that uses the new input modality of the feature, such that the parameterized model adapts how to best project input features into an internal embedding space of the parameterized model. In some embodiments, the decoder comprises a multi-attention head configured to receive the multi modal prompt and guide generation of the output response. In some embodiments, encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

In some embodiments, at least a portion of the response output by the decoder (of the trained parameterized model) is provided as feedback to the trained parameterized model. The portion of the response output by the trained parameterized model provided as feedback may be used as input for subsequent responses by the trained parameterized model. In some embodiments, the feedback is configured to iteratively refine the input to the trained parameterized model, while the trained parameterized model itself remains the same. In some embodiments, the feedback is used as input that is separate from, and in addition to, the multi modal inputs from the user. In some embodiments, the feedback comprises code, the output of executed code, and/or other feedback for example.

In some embodiments, the trained parameterized model is configured to store embedded features of mixed modalities from prior prompts in a feature database to create a library of features, to be used in combination with later prompts and/or context information to output responses. In some embodiments, using stored features to output responses to later prompts comprises performing a hierarchical feature search of the feature database and/or an external database to efficiently identify features related to a user query that can be provided as input to the trained parameterized model.

In some embodiments, the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A non-transitory computer readable medium having instructions thereon, the instructions when executed by a computer, causing the computer to output a zero-shot learning response to a multi modal prompt using a trained parameterized model, the trained parameterized model comprising encoder decoder architecture, the instructions causing the computer to perform operations comprising: receiving multi modal inputs from a user, the multi modal inputs comprising at least two different input modality types; encoding, with an encoder of the encoder decoder architecture, features of the multi modal inputs to form the multi modal prompt, the multi modal prompt comprising embedded features of mixed modalities from the at least two different input modality types; and providing the prompt to a decoder of the encoder decoder architecture to cause the decoder to output the response based on the multi modal prompt, the decoder configured to output the response without prior training on at least one of the multi modal inputs received from the user.

2. The medium of embodiment 1, wherein the multi modal inputs having the at least two different input modality types comprise two or more of text, image, video, audio, signal, byte sequence, code, and electromagnetic inputs.

3. The medium of any of the previous embodiments, wherein the electromagnetic inputs comprise radiofrequency (RF) waves, microwaves, light waves, and/or infrared radiation.

4. The medium of any of the previous embodiments, wherein the at least two different input modality types comprises at least three different input modality types.

5. The medium of any of the previous embodiments, wherein the operations further comprise receiving context information from the user, encoding the context information, and causing the decoder to output the response based on the multi modal prompt and encoded context information.

6. The medium of any of the previous embodiments, wherein the encoder need not be retrained to encode different multimodal inputs from the user, and instead is configured to be reused; and wherein the encoder is configured to encode both the features of the multi modal inputs to form the multi modal prompt and the context information to feed the decoder directly, without any added layers for combining features of different modes.

7. The medium of any of the previous embodiments, wherein the trained parameterized model comprises a large language model.

8. The medium of any of the previous embodiments, wherein the trained parameterized model comprises a transformer.

9. The medium of any of the previous embodiments, wherein the trained parameterized model further comprises a parietal space.

10. The medium of any of the previous embodiments, wherein the parameterized model comprises one or more neural networks.

11. The medium of any of the previous embodiments, wherein the encoder comprises a first neural network.

12. The medium of any of the previous embodiments, wherein the decoder comprises a second neural network.

13. The medium of any of the previous embodiments, wherein the trained parameterized model and/or the encoder decoder architecture comprises one or more adapters.

14. The medium of any of the previous embodiments, wherein the multi modal prompt comprises a single prompt, no matter how many different input modality types are included in the multi modal inputs received from the user.

15. The medium of any of the previous embodiments, wherein only key features of each of the multi modal inputs are encoded to form the multi modal prompt such that the multi modal prompt is relatively low dimensional compared to a dimensionality of any of the multi modal inputs, the key features being more predictive than other features of correct outputs during training of the parameterized model.

16. The medium of any of the previous embodiments, wherein training of the parameterized model is supervised or unsupervised.

17. The medium of any of the previous embodiments, wherein the training configures the parameterized model to learn a generic associativity of multi modal prompts, and once trained, to be deployed to output the zero-shot learning response to the multi modal prompt, without finetuning on new data types.

18. The medium of any of the previous embodiments, wherein the parameterized model is configured to solve a task involving new multi modal inputs by finding a closest match to the multi modal prompt in an embedding space, and then assigning the multi modal prompt to a most relevant class based on a similarity of the multi modal prompt to the most relevant class; wherein the decoder comprises a transformer decoder; and wherein, given a new input modality feature, the transformer decoder is finetuned for a task that uses the new input modality of the feature, such that the parameterized model adapts how to best project input features into an internal embedding space of the parameterized model.

19. The medium of any of the previous embodiments, wherein the decoder comprises a multi-attention head configured to receive the multi modal prompt and guide generation of the output response.

20. The medium of any of the previous embodiments, wherein the multi modal inputs having the at least two different input modality types comprise a first input comprising text, and a second input comprising an image, a video, audio input, a signal, a byte sequence, code, or an electromagnetic input.

21. The medium of any of the previous embodiments, wherein the multi modal inputs having the at least two different input modality types comprise a first input comprising an image, a video, audio input, a signal, a byte sequence, code, or an electromagnetic input, and a second input comprising a different one of the image, video, audio input, signal, byte sequence, code, or electromagnetic input.

22. The medium of any of the previous embodiments, wherein encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

23. The medium of any of the previous embodiments, wherein at least a portion of the response output by the trained parameterized model is provided as feedback to the trained parameterized model.

24. The medium of any of the previous embodiments, wherein the portion of the response output by the trained parameterized model provided as feedback is used as input for subsequent responses by the trained parameterized model.

25. The medium of any of the previous embodiments, wherein the feedback is configured to iteratively refine the input to the trained parameterized model, while the trained parameterized model itself remains the same.

26. The medium of any of the previous embodiments, wherein the feedback comprises code and/or output of executed code.

27. The medium of any of the previous embodiments, wherein the feedback is used as input that is separate from, and in addition to, the multi modal inputs from the user.

28. The medium of any of the previous embodiments, wherein the trained parameterized model is configured to store embedded features of mixed modalities from prior prompts in a feature database to create a library of features, to be used in combination with later prompts and/or context information to output responses.

29. The medium of any of the previous embodiments, wherein using stored features to output responses to later prompts comprises performing a hierarchical feature search of the feature database and/or an external database to efficiently identify features related to a user query that can be provided as input to the trained parameterized model.

30. The medium of any of the previous embodiments, wherein the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.

31. A method for outputting a zero-shot learning response to a multi modal prompt using a trained parameterized model, the trained parameterized model comprising encoder decoder architecture, the method comprising: receiving multi modal inputs from a user, the multi modal inputs comprising at least two different input modality types; encoding, with an encoder of the encoder decoder architecture, features of the multi modal inputs to form the multi modal prompt, the multi modal prompt comprising embedded features of mixed modalities from the at least two different input modality types; and providing the prompt to a decoder of the encoder decoder architecture to cause the decoder to output the response based on the multi modal prompt, the decoder configured to output the response without prior training on at least one of the multi modal inputs received from the user.

32. The method of embodiment 31, wherein the multi modal inputs having the at least two different input modality types comprise two or more of text, image, video, audio, signal, byte sequence, code, and electromagnetic inputs.

33. The method of any of the previous embodiments, wherein the electromagnetic inputs comprise radiofrequency (RF) waves, microwaves, light waves, and/or infrared radiation.

34. The method of any of the previous embodiments, wherein the at least two different input modality types comprises at least three different input modality types.

35. The method of any of the previous embodiments, further comprising receiving context information from the user, encoding the context information, and causing the decoder to output the response based on the multi modal prompt and encoded context information.

36. The method of any of the previous embodiments, wherein the encoder need not be retrained to encode different multimodal inputs from the user, and instead is configured to be reused; and wherein the encoder is configured to encode both the features of the multi modal inputs to form the multi modal prompt and the context information to feed the decoder directly, without any added layers for combining features of different modes.

37. The method of any of the previous embodiments, wherein the trained parameterized model comprises a large language model.

38. The method of any of the previous embodiments, wherein the trained parameterized model comprises a transformer.

39. The method of any of the previous embodiments, wherein the trained parameterized model further comprises a parietal space.

40. The method of any of the previous embodiments, wherein the parameterized model comprises one or more neural networks.

41. The method of any of the previous embodiments, wherein the encoder comprises a first neural network.

42. The method of any of the previous embodiments, wherein the decoder comprises a second neural network.

43. The method of any of the previous embodiments, wherein the trained parameterized model and/or the encoder decoder architecture comprises one or more adapters.

44. The method of any of the previous embodiments, wherein the multi modal prompt comprises a single prompt, no matter how many different input modality types are included in the multi modal inputs received from the user.

45. The method of any of the previous embodiments, wherein only key features of each of the multi modal inputs are encoded to form the multi modal prompt such that the multi modal prompt is relatively low dimensional compared to a dimensionality of any of the multi modal inputs, the key features being more predictive than other features of correct outputs during training of the parameterized model.

46. The method of any of the previous embodiments, wherein training of the parameterized model is supervised or unsupervised.

47. The method of any of the previous embodiments, wherein the training configures the parameterized model to learn a generic associativity of multi modal prompts, and once trained, to be deployed to output the zero-shot learning response to the multi modal prompt, without finetuning on new data types.

48. The method of any of the previous embodiments, wherein the parameterized model is configured to solve a task involving new multi modal inputs by finding a closest match to the multi modal prompt in an embedding space, and then assigning the multi modal prompt to a most relevant class based on a similarity of the multi modal prompt to the most relevant class; wherein the decoder comprises a transformer decoder; and wherein, given a new input modality feature, the transformer decoder is finetuned for a task that uses the new input modality of the feature, such that the parameterized model adapts how to best project input features into an internal embedding space of the parameterized model.

49. The method of any of the previous embodiments, wherein the decoder comprises a multi-attention head configured to receive the multi modal prompt and guide generation of the output response.

50. The method of any of the previous embodiments, wherein the multi modal inputs having the at least two different input modality types comprise a first input comprising text, and a second input comprising an image, a video, audio input, a signal, a byte sequence, code, or an electromagnetic input.

51. The method of any of the previous embodiments, wherein the multi modal inputs having the at least two different input modality types comprise a first input comprising an image, a video, audio input, a signal, a byte sequence, code, or an electromagnetic input, and a second input comprising a different one of the image, video, audio input, signal, byte sequence, code, or electromagnetic input.

52. The method of any of the previous embodiments, wherein encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

53. The method of any of the previous embodiments, wherein at least a portion of the response output by the trained parameterized model is provided as feedback to the trained parameterized model.

54. The method of any of the previous embodiments, wherein the portion of the response output by the trained parameterized model provided as feedback is used as input for subsequent responses by the trained parameterized model.

55. The method of any of the previous embodiments, wherein the feedback is configured to iteratively refine the input to the trained parameterized model, while the trained parameterized model itself remains the same.

56. The method of any of the previous embodiments, wherein the feedback comprises code and/or output of executed code.

57. The method of any of the previous embodiments, wherein the feedback is used as input that is separate from, and in addition to, the multi modal inputs from the user.

58. The method of any of the previous embodiments, wherein the trained parameterized model is configured to store embedded features of mixed modalities from prior prompts in a feature database to create a library of features, to be used in combination with later prompts and/or context information to output responses.

59. The method of any of the previous embodiments, wherein using stored features to output responses to later prompts comprises performing a hierarchical feature search of the feature database and/or an external database to efficiently identify features related to a user query that can be provided as input to the trained parameterized model.

60. The method of any of the previous embodiments, wherein the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.

What is claimed is:

1. A non-transitory computer readable medium having instructions thereon, the instructions when executed by a computer, causing the computer to output a zero-shot learning response to a multi modal prompt using a trained parameterized model, the trained parameterized model comprising encoder decoder architecture, the instructions causing the computer to perform operations comprising:
receiving multi modal inputs from a user, the multi modal inputs comprising at least two different input modality types;
encoding, with an encoder of the encoder decoder architecture, features of the multi modal inputs to form the multi modal prompt, the multi modal prompt comprising embedded features of mixed modalities from the at least two different input modality types; and
providing the prompt to a decoder of the encoder decoder architecture to cause the decoder to output the response based on the multi modal prompt, the decoder configured to output the response without prior training on at least one of the multi modal inputs received from the user.

2. The medium of claim 1, wherein the multi modal inputs having the at least two different input modality types comprise two or more of text, image, video, audio, signal, byte sequence, code, and electromagnetic inputs.

3. The medium of claim 2, wherein the electromagnetic inputs comprise radiofrequency (RF) waves, microwaves, light waves, and/or infrared radiation.

4. The medium of claim 1, wherein the at least two different input modality types comprises at least three different input modality types.

5. The medium of claim 1, wherein the operations further comprise receiving context information from the user, encoding the context information, and causing the decoder to output the response based on the multi modal prompt and encoded context information.

6. The medium of claim 5, wherein the encoder need not be retrained to encode different multimodal inputs from the user, and instead is configured to be reused; and wherein the encoder is configured to encode both the features of the multi modal inputs to form the multi modal prompt and the context information to feed the decoder directly, without any added layers for combining features of different modes.

7. The medium of claim 1, wherein the trained parameterized model comprises a large language model.

8. The medium of claim 1, wherein the trained parameterized model comprises a transformer.

9. The medium of claim 8, wherein the trained parameterized model further comprises a parietal space.

10. The medium of claim 1, wherein the parameterized model comprises one or more neural networks.

11. The medium of claim 1, wherein the encoder comprises a first neural network.

12. The medium of claim 1, wherein the decoder comprises a second neural network.

13. The medium of claim 1, wherein the trained parameterized model and/or the encoder decoder architecture comprises one or more adapters.

14. The medium of claim 1, wherein the multi modal prompt comprises a single prompt, no matter how many different input modality types are included in the multi modal inputs received from the user.

15. The medium of claim 1, wherein only key features of each of the multi modal inputs are encoded to form the multi modal prompt such that the multi modal prompt is relatively low dimensional compared to a dimensionality of any of the multi modal inputs, the key features being more predictive than other features of correct outputs during training of the parameterized model.

16. The medium of claim 1, wherein training of the parameterized model is supervised or unsupervised.

17. The medium of claim 16, wherein the training configures the parameterized model to learn a generic associativity of multi modal prompts, and once trained, to be deployed to output the zero-shot learning response to the multi modal prompt, without finetuning on new data types.

18. The medium of claim 1, wherein the parameterized model is configured to solve a task involving new multi modal inputs by finding a closest match to the multi modal prompt in an embedding space, and then assigning the multi modal prompt to a most relevant class based on a similarity of the multi modal prompt to the most relevant class;
wherein the decoder comprises a transformer decoder; and
wherein, given a new input modality feature, the transformer decoder is finetuned for a task that uses the new input modality of the feature, such that the parameterized model adapts how to best project input features into an internal embedding space of the parameterized model.

19. The medium of claim 1, wherein the decoder comprises a multi-attention head configured to receive the multi modal prompt and guide generation of the output response.

20. The medium of claim 1, wherein the multi modal inputs having the at least two different input modality types comprise a first input comprising text, and a second input comprising an image, a video, audio input, a signal, a byte sequence, code, or an electromagnetic input.

21. The medium of claim 1, wherein the multi modal inputs having the at least two different input modality types comprise a first input comprising an image, a video, audio input, a signal, a byte sequence, code, or an electromagnetic input, and a second input comprising a different one of the image, video, audio input, signal, byte sequence, code, or electromagnetic input.

22. The medium of claim 1, wherein encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

23. The medium of claim 1, wherein at least a portion of the response output by the trained parameterized model is provided as feedback to the trained parameterized model.

24. The medium of claim 23, wherein the portion of the response output by the trained parameterized model provided as feedback is used as input for subsequent responses by the trained parameterized model.

25. The medium of claim 24, wherein the feedback is configured to iteratively refine the input to the trained parameterized model, while the trained parameterized model itself remains the same.

26. The medium of claim 23, wherein the feedback comprises code and/or output of executed code.

27. The medium of claim 23, wherein the feedback is used as input that is separate from, and in addition to, the multi modal inputs from the user.

28. The medium of claim 1, wherein the trained parameterized model is configured to store embedded features of mixed modalities from prior prompts in a feature database to create a library of features, to be used in combination with later prompts and/or context information to output responses.

29. The medium of claim 28, wherein using stored features to output responses to later prompts comprises performing a hierarchical feature search of the feature database and/or an external database to efficiently identify features related to a user query that can be provided as input to the trained parameterized model.

30. The medium of claim 29, wherein the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.

31. A method for outputting a zero-shot learning response to a multi modal prompt using a trained parameterized model, the trained parameterized model comprising encoder decoder architecture, the method comprising:
receiving multi modal inputs from a user, the multi modal inputs comprising at least two different input modality types;
encoding, with an encoder of the encoder decoder architecture, features of the multi modal inputs to form the multi modal prompt, the multi modal prompt comprising embedded features of mixed modalities from the at least two different input modality types; and
providing the prompt to a decoder of the encoder decoder architecture to cause the decoder to output the response based on the multi modal prompt, the decoder configured to output the response without prior training on at least one of the multi modal inputs received from the user.

32. The method of claim 31, wherein the multi modal inputs having the at least two different input modality types comprise two or more of text, image, video, audio, signal, byte sequence, code, and electromagnetic inputs.

33. The method of claim 32, wherein the electromagnetic inputs comprise radiofrequency (RF) waves, microwaves, light waves, and/or infrared radiation.

34. The method of claim 31, wherein the at least two different input modality types comprises at least three different input modality types.

35. The method of claim 31, further comprising receiving context information from the user, encoding the context information, and causing the decoder to output the response based on the multi modal prompt and encoded context information.

36. The method of claim 35, wherein the encoder need not be retrained to encode different multimodal inputs from the user, and instead is configured to be reused; and wherein the encoder is configured to encode both the features of the multi modal inputs to form the multi modal prompt and the context information to feed the decoder directly, without any added layers for combining features of different modes.

37. The method of claim 31, wherein the trained parameterized model comprises a large language model.

38. The method of claim 31, wherein the trained parameterized model comprises a transformer.

39. The method of claim 38, wherein the trained parameterized model further comprises a parietal space.

40. The method of claim 31, wherein the parameterized model comprises one or more neural networks.

41. The method of claim 31, wherein the encoder comprises a first neural network.

42. The method of claim 31, wherein the decoder comprises a second neural network.

43. The method of claim 31, wherein the trained parameterized model and/or the encoder decoder architecture comprises one or more adapters.

44. The method of claim 31, wherein the multi modal prompt comprises a single prompt, no matter how many different input modality types are included in the multi modal inputs received from the user.

45. The method of claim 31, wherein only key features of each of the multi modal inputs are encoded to form the multi modal prompt such that the multi modal prompt is relatively low dimensional compared to a dimensionality of any of the multi modal inputs, the key features being more predictive than other features of correct outputs during training of the parameterized model.

46. The method of claim 31, wherein training of the parameterized model is supervised or unsupervised.

47. The method of claim 46, wherein the training configures the parameterized model to learn a generic associativity of multi modal prompts, and once trained, to be deployed to output the zero-shot learning response to the multi modal prompt, without finetuning on new data types.

48. The method of claim 31, wherein the parameterized model is configured to solve a task involving new multi modal inputs by finding a closest match to the multi modal prompt in an embedding space, and then assigning the multi modal prompt to a most relevant class based on a similarity of the multi modal prompt to the most relevant class;
wherein the decoder comprises a transformer decoder; and
wherein, given a new input modality feature, the transformer decoder is finetuned for a task that uses the new input modality of the feature, such that the parameterized model adapts how to best project input features into an internal embedding space of the parameterized model.

49. The method of claim 31, wherein the decoder comprises a multi-attention head configured to receive the multi modal prompt and guide generation of the output response.

50. The method of claim 31, wherein the multi modal inputs having the at least two different input modality types comprise a first input comprising text, and a second input comprising an image, a video, audio input, a signal, a byte sequence, code, or an electromagnetic input.

51. The method of claim 31, wherein the multi modal inputs having the at least two different input modality types comprise a first input comprising an image, a video, audio input, a signal, a byte sequence, code, or an electromagnetic input, and a second input comprising a different one of the image, video, audio input, signal, byte sequence, code, or electromagnetic input.

52. The method of claim 31, wherein encoding the features of the multi modal inputs to form the multi modal prompt and outputting the zero-shot learning response to the multi modal prompt decouples a training dataset from application of the parameterized model such that the parameterized model is trained to have generic associativity capabilities instead of outputting responses based a particular training dataset.

53. The method of claim 31, wherein at least a portion of the response output by the trained parameterized model is provided as feedback to the trained parameterized model.

54. The method of claim 53, wherein the portion of the response output by the trained parameterized model provided as feedback is used as input for subsequent responses by the trained parameterized model.

55. The method of claim 54, wherein the feedback is configured to iteratively refine the input to the trained parameterized model, while the trained parameterized model itself remains the same.

56. The method of claim 53, wherein the feedback comprises code and/or output of executed code.

57. The method of claim 53, wherein the feedback is used as input that is separate from, and in addition to, the multi modal inputs from the user.

58. The method of claim 31, wherein the trained parameterized model is configured to store embedded features of mixed modalities from prior prompts in a feature database to create a library of features, to be used in combination with later prompts and/or context information to output responses.

59. The method of claim 58, wherein using stored features to output responses to later prompts comprises performing a hierarchical feature search of the feature database and/or an external database to efficiently identify features related to a user query that can be provided as input to the trained parameterized model.

60. The method of claim 59, wherein the parameterized model is configured to solve a task involving new multi modal inputs by finding a closest match to the multi modal prompt in an embedding space, based on a result of the hierarchical feature search and/or the context information, and then assigning the multi modal prompt to a most relevant class based on a similarity of the multi modal prompt to the most relevant class.
